(19) United States
(12) Patent Application Publication
(10) Pub. No.: US 2021/0216126 A1
(43) Pub. Date: Jul. 15, 2021

(54) METHODS AND SYSTEMS FOR BATTERY MANAGEMENT

(71) Applicant: COMCAST CABLE COMMUNICATIONS, LLC, Philadelphia, PA (US)

(72) Inventor: Lewis Clay Dearman, Taylor, TX (US)

(21) Appl. No.: 16/741,203

(22) Filed: Jan. 13, 2020

(51) Int. Cl. G06F 1/28; G08B 21/18

(52) U.S. Cl. CPC G06F 1/28; H04B 1/3827; G08B 21/182

(57) ABSTRACT

Methods and systems for determining battery life are described. A computing device may determine a state of the computing device and a power usage of the computing device based on the state. The computing device may determine a capacity of a battery and a remaining battery life of the battery based on the power usage of the computing device.

### BACKGROUND

With the proliferation of battery powered devices, methods of estimating battery life are necessary to improve the user experience. Battery life estimation may enable a notification to a user of the battery powered device when a new battery is required. However, existing methods for determining battery life suffer from inaccuracies in determining the remaining life left in the battery. As a result, an accurate notification may not be provided to the user of the battery powered device. For example, two different non-rechargeable “AA” batteries may not have the same battery life (e.g., battery capacity) due to different manufacturers, variations in methods of manufacturing the batteries by the same manufacturer, different quality of batteries, environmental factors that impact battery life, and so forth. A more accurate determination may be made by measuring, with extra hardware, the power discharged from the battery as the device is used to determine the remaining battery life. However, the additional hardware increases the cost of the device, and a previously manufactured device may not have the additional hardware to measure the power discharged from the battery.

### SUMMARY

It is to be understood that both the following general description and the following detailed description are exemplary and explanatory only and are not restrictive. Methods and systems for determining battery life are described. A computing device may be configured to determine its power usage, without directly measuring the power usage. For example, the computing device may determine its power usage based on how long (e.g., a period of time) the computing device is in an operating state. The computing device may determine its operating state (e.g., a sleep state, an awake state, a transmit state, etc.) and a period of time spent in the operating state. The computing device may determine its power usage based on an analysis of the periods of time that the computing device was in each of the operating states.

The computing device may determine a storage capacity of its battery, which may indicate the remaining life in the battery. Further, the computing device may utilize one or more characteristics (e.g., resistance, voltage, etc.) of the battery to determine the storage capacity of the battery. Additionally, the computing device may identify the battery (e.g., type of battery, manufacturer of battery, etc.) based on the one or more characteristics of the battery to more accurately determine the storage capacity of the battery. For example, the battery may be identified based on the one or more characteristics, and the storage capacity of the battery may be determined based on the identity of the battery. The computing device may determine a remaining amount of power left in the battery based on the power usage and the storage capacity of the battery. Stated differently, the computing device may determine a remaining battery life of the battery. Further, the computing device may send the one or more characteristics of the battery and/or the power usage of the computing device to another computing device, and the another computing device may send the computing device the storage capacity of the battery and/or the remaining amount of power left in the battery. This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, show examples and together with the description, serve to explain the principles of the methods and systems:

FIG. 1 shows a block diagram of an example electronic device for determining battery life;

FIG. 2 shows an example system for determining battery life;

FIG. 3 shows an example system for determining battery life;

FIGS. 4A-4C show example graphs of characteristics of a battery;

FIG. 5 shows a flowchart of an example method for determining power usage;

FIG. 6 shows a flowchart of an example method for determining power usage;

FIG. 7 shows a flowchart of an example method for determining power usage;

FIG. 8 shows a flowchart of an example method for determining power usage;

FIG. 9 shows a flowchart of an example method for determining battery life;

FIG. 10 shows a flowchart of an example method for determining battery life;

FIG. 11 shows a flowchart of an example method for determining battery life;

FIG. 12 shows a flowchart of an example method for determining power usage;

FIG. 13 shows a flowchart of an example method for determining power usage;

FIG. 14 shows a flowchart of an example method for determining power usage; and

FIG. 15 shows an example block diagram of a computing device for determining power usage.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Throughout this application, reference is made to battery life of a battery, which may have different definitions based on whether the battery is a rechargeable battery or a non-rechargeable battery. For example, the battery life of a non-rechargeable battery may be a power amount and/or charge of the non-rechargeable battery such that once the charge and/or power amount is fully discharged (e.g., consumed), the battery life is zero because the battery is no longer usable. As another example, the battery life of a rechargeable battery may be a number of usage cycles (e.g., discharged via use and then charged) until the battery is no longer effective (e.g., does not hold a sufficient charge for a device's intended use of the battery). As an example, a rechargeable battery may have a battery life of 10 usage cycles such that the rechargeable battery may be discharged and charged a total of 10 times before the rechargeable battery no longer holds a sufficient charge when fully charged due to a diminished capacity of the rechargeable battery. Thus, the battery life of the rechargeable battery may be indicated by the capacity of the rechargeable battery such that when the capacity of the rechargeable battery is diminished to the point of no longer being effective for its intended use, the life of the rechargeable battery has ended even though the rechargeable battery is still usable because the rechargeable battery still holds a charge. Accordingly, the battery life and/or a remaining battery life of a battery may refer to the capacity for the battery to hold a charge, the charge and/or a power amount left in the battery, a number of usage cycles of the battery, and so forth.

Determining the life remaining in a battery can be critical to the user experience associated with battery powered devices (e.g., smartphones, laptops, personal electronics, Internet of Thing (IoT) devices, security devices, computing devices, etc.). Conventional techniques for determining remaining battery life comprise tracking battery voltage and battery temperature. However, a more accurate determination may be made by measuring the power discharged from the battery as the battery powered device is used. In an example, no additional hardware is necessary for measuring the power discharged from the battery by implementing a firmware and/or software method to determine the power discharged from the battery. As a result, existing devices already manufactured may gain this feature at no additional cost. In another example, hardware components (e.g., coulomb counters) that measure the power discharged from the battery may be used, however, additional hardware components may increase the cost of the device.

Battery powered devices go through known operating states during normal operation that consume varying amounts of power. For example, these states may comprise CPU sleep, CPU running, radio in receive (RX) mode, radio in transmit (TX) mode, sensor enabled and/or disabled, whether an application is running on the device, or any state that may be associated with a computing device as will be appreciated by one skilled in the art. A current draw for each of these states may be known. An approximate amount of power discharged from the battery may be determined by determining a time spent in each of the power states of the battery powered device, multiplying by the known current draw for each power state, and adding the products together to determine the amount of power used (e.g., power usage) by the battery powered device, which indicates the amount of power discharged from the battery. While the approximate power that has been discharged from the battery may be determined, a determination of a remaining amount of power (e.g., remaining charge, remaining capacity, etc.) of the battery is dependent on a remaining life (e.g., remaining power, remaining charge, remaining capacity, remaining usage cycles, etc.) of the battery. Accordingly, the remaining life of the battery may be determined, which indicates a remaining capacity of the battery and/or remaining charge of the battery. The remaining life of the battery may be determined based on one or more characteristics of the battery. The difference between the approximate power discharged by the battery and the battery capacity and/or remaining charge of the battery indicated by the remaining life of the battery may represent the amount of power remaining in the battery. A notification indicating the amount of power remaining in the battery and/or the remaining life of the battery may be generated and/or sent to indicate to a user whether the battery needs to be recharged and/or replaced.

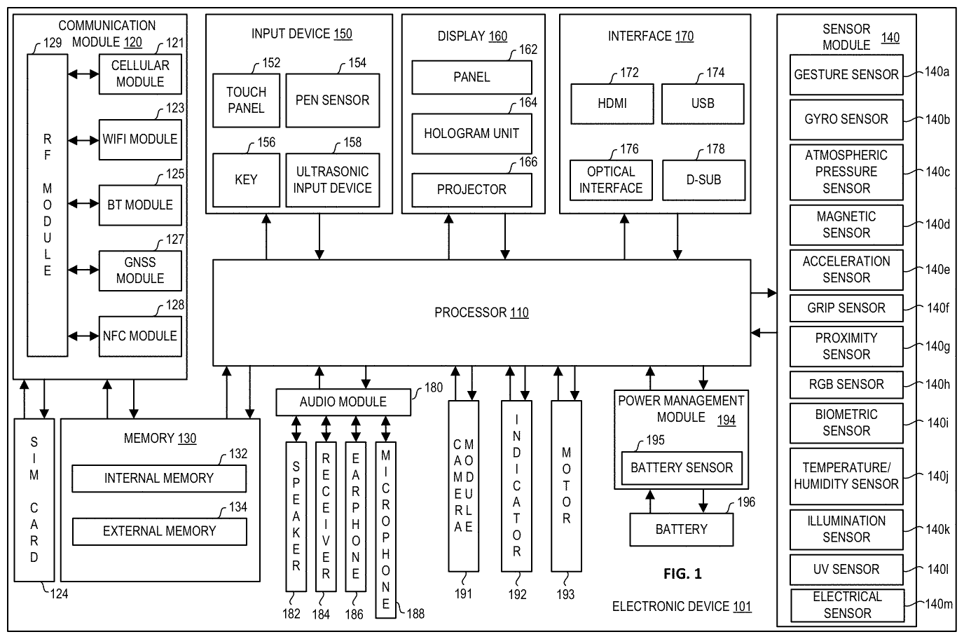

FIG. 1 shows a block diagram of an example battery powered device 101 for determining battery life. The electronic device 101 may comprise one or more processors (e.g., Application Processors (APs)) 110, a communication module 120, a subscriber identity module 124, a memory 130, a sensor module 140, an input unit 150, a display 160, an interface 170, an audio module 180, a camera module 191, an indicator 192, a motor 193, a power management module 194, a battery sensor 195 and/or a battery 196. In some examples, such as a tablet, an Internet of Things (IoT) device, a wearable device and so forth, the electronic device 101 may exclude the subscriber identity module 124.

The processor 110 may be configured to control a plurality of hardware and/or software constitutional elements connected to the processor 110 by driving, for example, an operating system or an application program, and may process a variety of data including multimedia data and may perform an arithmetic operation. The processor 110 may be implemented, for example, as a System on Chip (SoC), a controller a Central Processing Unit (CPU) or any processing element. The processor 110 may further comprise a Graphic Processing Unit (GPU) and/or an Image Signal Processor (ISP). The processor 110 may comprise one or more parts (e.g., a cellular module 121) of the aforementioned constitutional elements of FIG. 1. The processor 110 may process an instruction and/or data, which is received from at least one of different constitutional elements (e.g., a non-volatile memory), by loading the instruction and/or data to a volatile memory (e.g., the memory 130) and may store a variety of data in a non-volatile memory (e.g., the memory 130).

The communication module 120 may comprise, for example, the cellular module 121, a Wi-Fi module 123, a Bluetooth (BT) module 125, a Global Navigation Satellite System (GNSS) module 127 (e.g., a GPS module, a Gleans module, a Bijou module, or a Galileo module), a Near Field Communication (NFC) module 128, and a Radio Frequency (RF) module 129.

The cellular module 121 may be configured provide a voice call, a video call, a text service, an internet service, a data service, or the like through a communication network. The cellular module 121 may identify and authenticate the electronic device 101 in the communication network by using the subscriber identity module (e.g., a Subscriber Identity Module (SIM) card) 124. The cellular module 121 may perform at least some functions that may be provided by the processor 110. The cellular module 121 may comprise a Communication Processor (CP).

Each of the Wi-Fi module 123, the BT module 125, the GNSS module 127, or the NFC module 128 may comprise, for example, a processor for processing data transmitted/received via a corresponding module. According to a certain exemplary embodiment, at least some (e.g., two or more) of the cellular module 121, the Wi-Fi module 123, the BT module 125, the GPS module 127, and the NFC module 128 may be comprised in one Integrated Chip (IC) or IC package.

The RF module 129 may be configured transmit and/or receive a communication signal (e.g., a Radio Frequency (RF) signal). The RF module 129 may comprise a transceiver, a Power Amp Module (PAM), a frequency filter, a Low Noise Amplifier (LNA), an antenna, or the like. At least one of the cellular module 121, the Wi-Fi module 123, the BT module 125, the GPS module 127, and the NFC module 128 may transmit and/or receive an RF signal via a separate RF module.

The BT module 125 may be configured to communicate (e.g., pair with) with another electronic device (e.g., a wearable device, a microphone, a headset, etc.). For example, the electronic device 101 may communicate with the another electronic device to determine a remaining battery life of the another electronic device. As another example, the electronic device 101 may be configured to control the another device by communicating with the another electronic device via the BT module 125.

The subscriber identity module 124 may comprise, for example, a card including the subscriber identity module and/or an embedded SIM, and may comprise unique identification information (e.g., an Integrated Circuit Card Identifier (ICCID)) or subscriber information (e.g., an International Mobile Subscriber Identity (IMSI)).

The memory 130 may be configured to store one or more application programs, including, for example, an application program to determine the remaining battery life of the electronic device 101. The memory 130 may be further configured to store data. For example, the memory 130 may store data related to one or more characteristics of the battery 196, as well as data related to the operating state and/or usage of the electronic device 101. The memory 130 may comprise, for example, an internal memory 132 or an external memory 134. The internal memory 132 may comprise, for example, at least one of a volatile memory (e.g., a Dynamic RAM (DRAM), a Static RAM (SRAM), a Synchronous Dynamic RAM (SDRAM), etc.) and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory, a NOR flash memory, etc.), a hard drive, or a Solid State Drive (SSD)).

The external memory 134 may further comprise a flash drive, for example, Compact Flash (CF), Secure Digital (SD), Micro Secure Digital (Micro-SD), Mini Secure digital (Mini-SD), extreme Digital (xD), memory stick, or the like. The external memory 134 may be operatively and/or physically connected to the electronic device 101 via various interfaces.

The sensor module 140 may measure, for example, a physical quantity or detect an operational status of the electronic device 101, and may convert the measured or detected information into an electric signal. Additionally, the sensor module 140 may measure one or more characteristics associated with the environment surrounding the electronic device 101. The sensor module 140 may comprise, for example, at least one of a gesture sensor 140a, a gyro sensor 140b, an atmospheric pressure sensor 140c, a magnetic sensor 140d, an acceleration sensor 140e, a grip sensor 140f, a proximity sensor 140g, a color sensor 140h (e.g., a Red, Green, Blue (RGB) sensor), a biometric sensor 140i, a temperature/humidity sensor 140j, an illumination sensor 140k, an Ultra Violet (UV) sensor 140l, and an electrical sensor 140m. The biometric sensor 140l may be an optical sensor configured to detect ambient light and/or light reflected by an external object (e.g., a user's finger), and which is converted into a specific wavelength band by means of a light converting member. Additionally or alternatively, the sensor module 140 may comprise, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor module 140 may further comprise a control circuit for controlling at least one or more sensors comprised therein. In a certain exemplary embodiment, the electronic device 101 may further comprise a processor configured to control the sensor module 140 either separately or as one part of the processor 110, and may control the sensor module 140 while the processor 110 is in a sleep state.

The electrical sensor 140m may be any sensor configured to determine one or more characteristics and/or properties of the electronic device 101 and/or the environment surrounding the electronic device 101. For example, the electrical sensor 140m may be a heart rate sensor, a glass break sensor, a sensor that indicates whether a door is open or closed, a smoke sensor, a gas sensor (e.g., a carbon monoxide sensor), and so forth.

The input device 150 may comprise, for example, a touch panel 152, a (digital) pen sensor 154, a key 156, or an ultrasonic input device 158. The touch panel 152 may be configured recognize a touch input, for example, by using at least one of an electrostatic type, a pressure-sensitive type, and/or an ultrasonic type. In addition, the touch panel 152 may further comprise a control circuit. The touch panel 152 may further be configured to provide the user with a tactile reaction via a tactile layer and/or provide the user with a tactile sensation via one or more electrical signals.

The (digital) pen sensor 154 may be, for example, one part of a touch panel, or may comprise an additional sheet for recognition. The key 156 may be, for example, a physical button, an optical key, a keypad, and/or a touch key. The ultrasonic input device 158 may detect an ultrasonic wave generated from an input means through a microphone (e.g., a microphone 188) to confirm data corresponding to the detected ultrasonic wave.

The display 160 may comprise a panel 162, a hologram unit 164, or a projector 166. The panel 162 may be implemented, for example, in a flexible, transparent, or wearable manner. The panel 162 may be constructed as one module with the touch panel 152. The panel 162 may comprise a pressure sensor (or a force sensor) capable of measuring strength of pressure for a user's touch. The pressure sensor may be implemented in an integral form with respect to the touch panel 152, or may be implemented as one or more sensors separated from the touch panel 152.

The hologram unit 164 may use an interference of light and show a stereoscopic image in the air. The projector 166 may display an image by projecting a light beam onto a screen. The screen may be located, for example, inside or outside the electronic device 101. According to one exemplary embodiment, the display 160 may further comprise a control circuit for controlling the panel 162, the hologram unit 164, or the projector 166.

The interface 170 may comprise, for example, a High-Definition Multimedia Interface (HDMI) 172, a Universal Serial Bus (USB) 174, an optical communication interface 176, or a D-subminiature (D-sub) 178. Additionally or alternatively, the interface 170 may comprise, for example, a Mobile High-definition Link (MHL) interface, a Secure Digital (SD)/Multi-Media Card (MMC) interface, an Infrared Data Association (IrDA) standard interface, and/or any interface that is capable of sending and/or receiving data and/or signals (e.g., communications) to/from the electronic device 101.

The audio module 180 may be configured to bilaterally convert, for example, a sound and/or electric signal. The audio module 180 may convert sound information which is input or output, for example, through a speaker 182, a receiver 184, an earphone 186, the microphone 188, or the like.

The camera module 191 may be, for example, a device for image and/or video capturing. That is, the camera module 191 may be configured to capture still images and or videos. The camera module 191 may comprise one or more image sensors (e.g., a front image sensor, a rear image sensor, etc.), a lens, an Image Signal Processor (ISP), or a flash (e.g., a Light Emitting Diode (LED), xenon lamp, etc.).

The indicator 192 may display a specific state, for example, a booting state, a message state, a charging state, or the like, of the electronic device 101 or one part thereof (e.g., the processor 110). The motor 193 may convert an electric signal into a mechanical vibration, and may generate a vibration or haptic effect.

The power management module 194 may be configured to manage, for example, power of the electronic device 101. According to one exemplary embodiment, the power management module 194 may comprise a Power Management Integrated Circuit (PMIC), a charger Integrated Circuit (IC), or a battery fuel gauge. The PMIC may have a wired and/or wireless charging type. The wireless charging type may comprise, for example, a magnetic resonance type, a magnetic induction type, an electromagnetic type, or the like, and may further comprise an additional circuit for wireless charging, for example, a coil loop, a resonant circuit, a rectifier, or the like.

The power management module 194 may have a battery sensor 195. The battery sensor 195 may be configured to determine one or more characteristics of the battery 196. The one or more characteristics of the battery 196 may be at least one of a voltage, a resistance, a current, a temperature, a quiescent voltage, and/or a capacity of the battery 196. The power management module 194 may utilize the battery sensor 195 to measure, for example, residual quantity of the battery 196 and voltage, current, and temperature during charging. The power management module 194 may be configured to modify the amount of power (e.g., current) provided to the battery 196 during charging based on one or more measurements of the battery sensor 195. For example, the power management module 194 may modify the amount of power provided to the battery 196 to ensure that the battery 196 is not damaged. As an example, the power management module 194 may reduce the amount of power provided to the battery 196 if the battery 196 is almost fully charged (e.g., charged above 90% of the capacity of the battery 196).

The battery 196 may comprise, for example, a non-rechargeable battery, a rechargeable battery, and/or a solar battery. For example, the battery 196 may be a non-rechargeable battery and/or a rechargeable battery. The battery 196 may be any size and/or type of battery. For example, the battery 196 may be a cylindrical battery (e.g., AAA, C, D, CR2, 2CR5, etc.), a rectangular battery (9 volt, 12 volt, etc.), a button cell battery (e.g., CR927, CR1220, CR2025, etc.), a zinc air cell battery (e.g., AC10, ZA13, A312, etc.), and so forth. The battery 196 may be made of any material such as alkaline, carbon zinc, Lithium-ion (Li-ion), Nickel Cadmium (Ni—Cd), Nickel-Metal Hydride (Ni-MH), Lithium-Manganese Dioxide (LiMnO₂), or any suitable battery.

The battery 196 may have a storage capacity, which is the total amount of power (e.g., charge) that the battery 196 can store. The storage capacity of the battery 196 may or may not change over time. For example, if the battery 196 is a non-rechargeable battery, the storage capacity may not change over time because the capacity is a fixed amount since the battery 196 is not capable of being recharged. As another example, if the battery 196 is a rechargeable battery, the storage capacity of the battery may change over time as the battery 196 is used. For example, as the battery 196 is used (e.g., power is discharged from the battery 196, the battery 196 is charged, etc.), the capacity of the battery 196 may decrease due to the use. Thus, the capacity of the battery 196 may change overtime, which may impact determining the amount of power remaining in the battery 196. The electronic device 101 may be configured to determine the capacity of the battery 196 based on one or more characteristics of the battery 196 and/or use of the battery 196 to account for any change in the capacity of the battery 196. Accordingly, the electronic device 101 may be configured to take into account the change in the capacity of the battery 196 when determining a remaining power left in the battery 196.

The battery 196 may have a battery life associated with the battery 196. For example, the battery 196 may be a rechargeable battery that has a number of usage cycles (e.g., charged and discharged) that the battery 196 can have before the battery is no longer effective (e.g., does not hold a sufficient charge for the electronic device 101's intended use of the battery 196). As an example, the battery 196 may have a battery life of 10 usage cycles such that the battery 196 may be discharged and charged a total of 10 times before the battery 196 no longer holds a sufficient charge when fully charged due to a diminished capacity of the battery 196. The battery life of the battery 196 may be indicated by a capacity of the battery 196. For example, when the capacity of the rechargeable battery is diminished (e.g., reduced) to the point of no longer being effective for its intended use, the life of the battery 196 may be considered ended even though the battery 196 is still usable because the battery 196 still holds a charge. Thus, when the battery life satisfies a threshold (e.g., when the capacity is reduced to the point that the threshold is satisfied), a notification may be generated and/or sent to indicate that the battery life of the battery 196 is near the end of the effective life of the battery 196, and the battery 196 needs to be replaced. As an example, when the capacity of the battery 196 is reduced to a percentage (e.g., 50%, 60%, 70%, etc.) as compared to the capacity of the battery 196 when new (e.g., 100%), the notification may be generated and/or sent to indicate the that the battery 196 needs to be replaced.

The electronic device 101 may be configured to determine an operating state of the electronic device 101. The operating state of the electronic device 101 may be at least one of a sleep state, a charge state, an awake state, a transmit state, a receive state, a sensor active state, a sensor inactive state, or combinations of these states. Additionally, the operating state of the electronic device 101 may comprise a use state that comprises any usage of one or more of software and/or firmware associated with the electronic device 101. For example, the electronic device 101 may have one or more applications installed on the electronic device 101 that each may be used (e.g., run) by a user of the electronic device 101.

Each of the operating states of the electronic device 101 may use different amounts of current. The operating states may each have a respective current draw, and one or more of the operating states may not have a current draw. For example, during a charge state of the electronic device 101 (e.g., when the battery 196 is being charged via an external power source), the charge state may not have a current draw as the charge state is providing power to the battery 196 rather than discharging power (e.g., pulling current) from the battery 196. Some non-limiting examples of current draws associated with the operating states are that the sleep state may use 600 nA of current per hour, the awake state may use 12 mA of current per hour, the transmit state may use 145 mA of current per hour, the receive state may use 35 mA per hour, and the sensor on state may use 6 μA per hour.

As another example, the use state may have different current draw based on the quantity of applications running on the electronic device 101. Each application may have an associated current draw associated with being run by the electronic device 101. The use state may comprise the current draw for each of the applications being run on the electronic device 101, and each of the applications may have a respective current draw. Additionally, the current draw of the applications may vary based on how the applications are used. For example, an application for streaming content may not use a lot of current as the user is browsing for content to consume (e.g., watch), but when the application begins streaming content, the current draw may increase significantly due to the amount of processing power required to request the content, receive the content, process the content, and cause output of the content for the user. The electronic device 101 may monitor the current draw for each application during the use state to determine the individual current draw for each application, as well as the total (e.g., a summation of the current draw for each application) current usage during the use state. As will be appreciated by one skilled in the art, the current draw for the various states of the electronic device 101, as well as the application on the electronic device 101, will vary depending on the design of the electronic device 101 and the applications. Thus, the current draw and/or power usage for the various states of the electronic device 101 should not be limited to the aforementioned examples.

The electronic device 101 may determine a power usage of the electronic device 101. The power usage of the electronic device 101 may be determined based on the operating state of the electronic device 101. The power usage of the electronic device 101 may be determined based on a period of time that the electronic device 101 is in the operating state. The power usage of electronic device 101 may be determined without measuring the power usage of the electronic device 101. That is, the power usage of electronic device 101 may be determined by software and/or firmware without using a piece of hardware to determine the power usage. For example, the electronic device 101 may multiply the period of time that the electronic device 101 was in a given operating state times the current draw for the given state to determine the power usage. The electronic device 101 may send the power usage of the electronic device 101 to the another device (e.g., a computing device, a network device, etc.).

The electronic device 101 may determine an identity of the battery 196. For example, the identity of the battery 196 may not be known to the electronic device 101. As an example, the battery 196 may be a battery that was installed by a manufacturer of the electronic device 101, and the user of the electronic device 101 may replace the battery 196 with a different battery. Thus, the identity of the different battery is not known to the electronic device 101 because the user may have used any suitable battery (e.g., the correct type of battery, but a different manufacturer).

The identity of the battery 196 may be determined (e.g., by the electronic device 101) based on one or more characteristics of the battery 196. The one or more characteristics of the battery 196 may be at least one of a voltage, a resistance, a current, a temperature, a quiescent voltage, and so forth. For example, the electronic device 101 may determine the one or more characteristics of the battery 196 by measuring (e.g., via a sensor or another measuring device) the one or more characteristics of the battery. Additionally, the one or more characteristics of the battery 196 may be determined under different conditions such as a voltage during a max load of the battery 196.

The electronic device 101 may utilize the determined one or more characteristics of the battery 196 determine the identity of the battery 196 to determine one or more attributes about the battery 196, such as a manufacturer of the battery 196, a storage capacity of the battery 196, a type of the battery 196, a battery life (e.g. life span) of the battery 196, a chemical makeup of the battery 196, and so forth. The determined one or more characteristics of the battery 196 may be utilized (e.g., by the electronic device 101) to identify a known battery (e.g., via machine learning, compared to characteristics of previously known batteries, etc.) to determine the one or more attributes of the battery 196 based on the determined one or more characteristics. For example, a same type of battery (e.g., a AA battery) made by different manufacturers may have different attributes that impact the operation of the battery 196, as well as characteristics that the electronic device 101 may utilize to determine the identity of the battery 196. As an example, if a generic AA battery has a resistance of 10 ohms and voltage of 2.14 V and the determined one or more characteristics of the battery 196 are a resistance of 9.8 ohms and a voltage of 2.1 V, the identity of the battery 196 may be determined to be the generic AA battery due to the similarity in the one or more characteristics (e.g., the resistance and the voltage). Thus, the battery 196 likely has similar attributes as the generic AA battery. Accordingly, the one or more attributes of the battery 196 may be determined based on the one or more characteristics of the battery 196.

The electronic device 101 may determine a remaining power amount of the battery 196. The electronic device 101 may determine the remaining power amount of the battery 196 based on the power usage of the electronic device 101. The electronic device 101 may determine the remaining power amount of the battery 196 based on the storage capacity of the battery 196. The electronic device 101 may determine the remaining power amount of the battery 196 based on the storage capacity of the battery 196 and the power usage of the electronic device 101. For example, the electronic device 101 may subtract the determined power usage from the storage capacity of the battery 196 to determine the remaining power amount of the battery 196. As an example, the electronic device 101 may determine that the battery 196 has a storage capacity of 2,000 mAh. Further, the electronic device 101 may determine that the power usage of the electronic device 101 is 500 mAh. The electronic device 101 may determine that the remaining power amount of the battery 196 is 1,500 mAh (e.g., 2,000 mAh-500 mAh).

The electronic device 101 may generate and/or send a notification based on the remaining power amount of the battery 196. For example, the electronic device 101 may generate the notification and cause the notification to be displayed (e.g., via the display 160) to a user of the electronic device 101 and/or send the notification to another device. As another example, the electronic device 101 may generate and/or send the notification when the remaining power amount of the battery 196 satisfies a threshold. The threshold may indicate a remaining charge of the battery 196. The threshold may be based on the voltage of the battery 196, a remaining capacity of the battery 196, and so forth. When the remaining power amount of the battery 196 satisfies the threshold (e.g., reaches the threshold), the electronic device 101 may send a notification indicating the remaining power amount of the battery 196. For example, the threshold may be satisfied when the remaining power amount of the battery 196 is 10% of the fully charged power of the battery 196, and the electronic device 101 may send the notification when the remaining power amount of the battery 196 reaches 10%. The notification may indicate one or more actions to take based on the remaining power amount of the battery 196. As an example, the notification may indicate that the battery 196 needs to be replaced and/or recharged because the remaining power amount of the battery 196 is below the threshold. As another example, the notification may indicate that the battery needs to be replaced and/or recharged within a period of time (e.g., a week, a month, 6 months, etc.). The period of time may be based on a daily power usage of the electronic device 101. Thus, the electronic device 101 may generate and/or send a notification indicating when the battery 196 needs to be replaced and/or recharged.

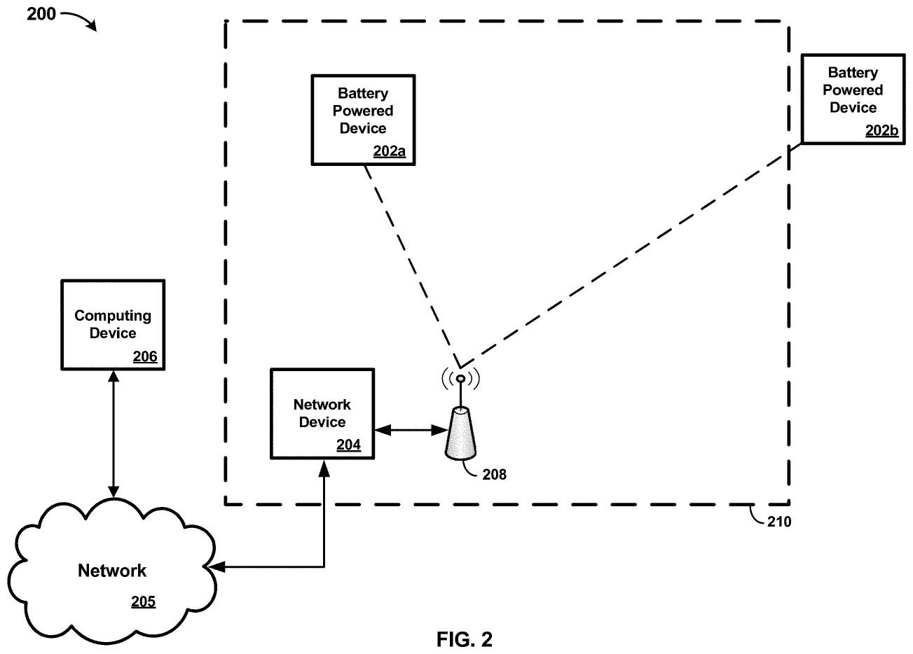

FIG. 2 shows an example system 200 for determining battery life. Those skilled in the art will appreciate that digital equipment and/or analog equipment may be employed. One skilled in the art will appreciate that provided herein is a functional description and that the respective functions may be performed by software, hardware, or a combination of software and hardware.

The system 200 may have battery powered devices 202a,b, a network device 204, and a computing device 206. The system 200 also comprises a premises 210 where the network device 204, a wireless access point 210, and the user devices 202 are located. The battery powered devices 202a,b can comprise the capabilities of the electronic device 101 of FIG. 1. As will be appreciated by one skilled in the art, the system 200 may have any quantity of battery powered devices 202, network devices 204, and/or computing devices 206. The battery powered devices 202 may be an electronic device such as a computer, a smartphone, a laptop, a tablet, a set top box, a display device, a wearable device, Consumer Premises Equipment (CPE), or other battery powered device. Additionally, the battery powered devices 202 may be Internet of Things (IoT) devices such as any low powered electronic device which may comprise a smart device (e.g., a smart thermostat, a home electronic hub, etc.). The battery powered devices 202 may be a security system, which may comprise, but is not limited to, an electronic camera, a smart doorbell, a glass break sensor, a motion sensor, a window and/or door open sensor, and so forth. The battery powered device 202a may be located within the premises 210, while the battery powered device 202b may be located outside the premises 210.

The battery powered devices 202 may be configured to send a request for a capacity of a battery associated with the battery powered devices 202. The request may be sent to another device (e.g., the network device 204, the computing device 206, etc.). The request may indicate one or more characteristics of the battery. For example, the battery powered devices 202 may be configured to determine the one or more characteristics of the battery. The one or more characteristics of the battery may be at least one of a voltage, a resistance, a current, a temperature, a quiescent voltage, and so forth. The battery powered devices 202 may be configured to receive the capacity of the battery from the other device. The capacity of the battery may indicate a total available charge of the battery.

The battery powered device 202 may be pre-configured with the capacity of the battery associated with the battery powered devices 202. For example, the battery powered device 202 may be pre-programed with information that indicates the capacity of the battery. Thus, the battery powered devices 202 can determine the capacity of the battery based on the pre-configured information that indicates the capacity of the battery.

The battery powered devices 202 may be configured to determine an operating state of the battery powered devices 202. Each of the operating states of the battery powered device 202 may use different amounts of current. The battery powered devices 202 may determine a power usage of the battery powered devices 202. The power usage of the battery powered devices 202 may be determined based on the operating state of the battery powered devices 202. The power usage of the battery powered devices 202 may be determined based on a period of time that the battery powered devices 202 are in the operating state. The power usage of the battery powered devices 202 may be determined without measuring the power usage of the battery powered devices 202. That is, the power usage of battery powered devices 202 may be determined by software and/or firmware without using a piece of hardware to determine the power usage. For example, the battery powered devices 202 may multiply the period of time that the battery powered devices 202 were in a given operating state with the current draw for the given state to determine the power usage for the given state, and then sum the power usage for one or more of the states to determine the power usage of the battery powered devices 202. The battery powered devices 202 may send the power usage of the battery powered devices 202 to the network device 204 and/or the computing device 206 via the network device 204.

The battery powered devices 202 may determine a remaining power amount of the battery. The battery powered devices 202 may determine the remaining power amount of the battery based on the power usage of battery powered devices 202. For example, the battery powered device 202 may determine the power usage of the battery powered devices 202, as explained in the previous paragraph, and the battery powered devices 202 may utilize this information to determine the remaining power amount of the battery. The battery powered devices 202 may determine the remaining power amount of the battery based on the storage capacity of the battery. The battery powered devices 202 may determine the remaining power amount of the battery based on the storage capacity of the battery and the power usage of the battery powered devices 202. For example, the battery powered devices 202 may subtract the determined power usage from the storage capacity of the battery to determine the remaining power amount of the battery. As an example, the battery powered device 202a may determine the battery has a storage capacity of 2,000 mAh. Further, the battery powered device 202a may determine that the power usage of the battery powered devices 202a is 500 mAh. The battery powered device 202a may determine that the remaining power amount of the battery is 1,500 mAh (e.g., 2,000 mAh-500 mAh).

The battery powered devices 202 may be configured to send a request for a remaining battery life of the battery associated with the battery powered devices 202. The request may be sent to another device (e.g., the network device 204, the computing device 206, etc.). For example, the battery powered device 202a may not have the information (e.g., data) and/or the processing capability to determine the remaining battery life of the battery associated with the battery powered device 202a. Thus, the battery powered device 202a may send a request to another device to determine the battery life of the battery associated with the battery powered device 202a. The request may indicate one or more characteristics of the battery. For example, the battery powered devices 202 may be configured to determine the one or more characteristics of the battery. The one or more characteristics of the battery may be at least one of a voltage, a resistance, a current, a temperature, a quiescent voltage, and so forth. The battery powered devices 202 may be configured to receive the remaining battery life of the battery from the other device. The remaining battery life of the battery may indicate the capacity of the battery.

The battery powered devices 202 may determine a remaining power amount of the battery based on the remaining battery life of the battery. The battery powered devices 202 may determine the remaining power amount of the battery based on the power usage of battery powered devices 202 and based on the capacity of the battery as indicate by the remaining battery life of the battery. For example, the battery powered devices 202 may subtract the determined power usage from the storage capacity of the battery to determine the remaining power amount of the battery. Thus, the battery powered devices may be configured to take into the remaining life of the battery to determine the remaining power amount of the battery.

The battery powered devices 202 may send a notification based on the remaining power amount of the battery. For example, the battery powered devices 202 may send a notification to a user device when the remaining power amount of the battery satisfies a threshold. When the remaining power amount of the battery satisfies the threshold (e.g., reaches the threshold), the battery powered devices 202 may send a notification indicating the remaining power amount of the battery. For example, the threshold may be satisfied when the remaining power amount of the battery is 10% of the fully charged power of the battery, and the battery power devices 202 may send the notification when the remaining power amount of the battery reaches 10%. The notification may indicate one or more actions to take based on the remaining power amount of the battery. As an example, the battery powered devices 202 may send a notification that the battery needs to be replaced because the remaining power amount of the battery is below the threshold. As another example, the notification may indicate that the battery needs to be replaced within a period of time (e.g., a week, a month, 6 months, etc.). The period of time may be based on a daily power usage of the battery powered devices 202. Thus, the battery powered device 202 may send a notification indicating when the battery needs to be replaced.

The network device 204 may be a wireless communication device (e.g., a wireless router, a gateway, an access point, etc.). The network device 204 may utilize a communication protocol to provide a wireless communications network (e.g., Wi-Fi, Bluetooth, etc.). The battery powered devices 202 may communicate with the network device 204 via the wireless communication network. The battery powered devices 202 may utilize the Wi-Fi network to communicate with the network device 204. The battery powered devices 202 may communicate via the network device 204 to access a service, such as the Internet, or to communicate with another device (e.g., the computing device 206). The battery powered devices 202 may send the network device 204 data associated with the battery powered devices 202. For example, the battery powered devices 202 may send the network device 204 data that indicates an operating state, a period of time associated with the operating state, and/or one or more characteristics of a battery associated with the battery powered devices 202.

The network device 204 may be configured to communicate with the network 205. The network device 204 may be a modem (e.g., cable modem), a router, a gateway, a switch, a network terminal (e.g., optical network unit), and/or the like. The network device 204 may be configured for communication with the network 205 via a variety of protocols, such as internet protocol, transmission control protocol, file transfer protocol, session initiation protocol, voice over internet protocol, and/or the like. The network device 204 may be configured to provide network access via a variety of communication protocols and standards, such as Data Over Cable Service Interface Specification (DOCSIS).

The network device 204 may be in communication with a wireless access point 208. The wireless access point 208 may be configured to provide one or more wireless networks in at least a portion of the premises 210. The wireless access point 208 may be configured to provide access to the network 205, via the network device 204, to devices configured with a compatible wireless radio, such as the battery powered devices 202. For example, the wireless access point 208 may provide a user managed network (e.g., local area network), a service provider managed network (e.g., public network for users of the service provider), and/or the like. While the wireless access point 208 is shown as a separate device from the network device 204 for ease of explanation, a person skilled in the art would appreciate that the network device 204 may comprise the capabilities of the wireless access point 208.

The network device 204 may receive data that indicates a period of time that the battery powered devices 202 are in an operating state. The network device 204 may determine a power usage of the battery powered devices 202. The power usage of the battery powered devices 202 may be determined based on the period of time that the battery powered device 202 are in a given operating state. The power usage of the battery powered devices 202 may be determined without measuring the power usage of the battery powered devices 202. For example, the power usage of the given operating state may be multiplied by the period of time that the battery powered devices 202 are in the given operating state to determine the power usage of the battery powered devices 202, which does not require measuring a current draw or power usage of the battery powered devices 202.

The network device 204 may receive one or more characteristics of a battery. The one or more characteristics of the battery may be received from the battery powered devices 202. The battery may be associated with the battery powered devices 202. The one or more characteristics of the battery may be at least one of a voltage, a resistance, a current, a temperature, a quiescent voltage, and/or a voltage during a max load of the battery. The network device 204 may determine an identity of the battery. The identity of the battery may indicate a manufacturer of the battery, the storage capacity of the battery, a type of the battery, a life span of the battery, a maximum potential storage capacity of the battery, and so forth. The identity of the battery may be determined based on the one or more characteristics of the battery.

The network device 204 may be configured determine a storage capacity of the battery of the battery powered devices 202. The storage capacity of the battery may be determined based on the one or more characteristics of the battery. The one or more characteristics of the battery may be at least one of a voltage, a resistance, a current, a temperature, a quiescent voltage, and/or a voltage during a max load of the battery. The network device 204 may be configured to receive a request for the storage capacity of the battery of the battery powered device 202, and the network device 204 may be configured to send the determine storage capacity of the battery to the battery powered devices 202.

The network device 204 may determine a remaining amount of power of the battery of the battery powered devices 202. The network device 204 may determine the remaining power amount of the battery based on the power usage of the battery powered devices 202. The network device 204 may determine the remaining power amount of the battery based on the storage capacity of the battery. The network device 204 may determine the remaining power amount of the battery based on the storage capacity of the battery and the power usage of the battery powered devices 202.

The network device 204 may send a notification that indicates the remaining power of the battery of the battery powered devices 202. The network device 204 may send the notification to the battery powered devices 202. The network device 204 may send the notification to a user device and/or the computing device 206. The notification may indicate that the battery of the battery powered devices 202 needs to be replaced. For example, the network device 204 may send a notification to a user device when the remaining power amount of the battery satisfies a threshold. The threshold may indicate a remaining life of the battery. The threshold may be based on the voltage of the battery, a remaining capacity of the battery, and so forth. When the remaining power amount of the battery satisfies the threshold (e.g., reaches the threshold), the network device 204 may send the notification indicating the remaining power amount of the battery.

The network device 204 may communicate with the computing device 206 via the network 205. The computing device 206 may be a server that is located remotely from the network device 204. The computing device 206 may be associated with a content provider and/or an Internet Service Provider (ISP). The computing device 206 may communicate with a plurality of network devices 204 located at a plurality of premises 210. The plurality of premises 210 may each be associated with a separate location. The network device 204 may send (e.g., provide) the computing device 206 data associated with the battery powered devices 202.

The computing device 206 may receive the data from the network device 204. The computing device 206 may receive one or more characteristics of a battery. The one or more characteristics of the battery may be received from the battery powered devices 202. The battery may be associated with the battery powered devices 202. The one or more characteristics of the battery may be at least one of a voltage, a resistance, a current, a temperature, a quiescent voltage, and/or a voltage during a max load of the battery. The computing device 206 may determine an identity of the battery. The identity of the battery may indicate one or more attributes of the battery. The one or more attributes may be a manufacturer of the battery, the storage capacity of the battery, a type of the battery, a life span of the battery, a maximum potential storage capacity of the battery, and so forth. Additionally, the one or more attributes may comprise a recharge rate of the battery, a number of charges left, a maximum number of charges, how the battery handles charging and discharging (e.g., life of battery significantly reduced if the battery is constantly plugged in, brought from 0% to 100% constantly, etc.). The identity of the battery may be determined based on the one or more characteristics of the battery.

The computing device 206 may determine a storage capacity of the battery of the battery powered devices 202. The storage capacity of the battery may be determined based on the one or more characteristics of the battery. The one or more characteristics of the battery may be at least one of a voltage, a resistance, a current, a temperature, a quiescent voltage, and/or a voltage during a max load of the battery. The network device 204 may be configured to receive a request for the storage capacity of the battery of the battery powered device 202, and the network device 204 may be configured to send the determine storage capacity of the battery to the battery powered devices 202.

The computing device 206 may determine a remaining amount of power of the battery of the battery powered devices 202. The computing device 206 may determine the remaining power amount of the battery based on the power usage of the battery powered devices 202. The computing device 206 may determine the remaining power amount of the battery based on the storage capacity of the battery. The computing device 206 may determine the remaining power amount of the battery based on the storage capacity of the battery and the power usage of the battery powered devices 202.

The computing device 206 may send a notification that indicates the remaining power of the battery of the battery powered devices 202. The computing device 206 may send the notification to the battery powered devices 202. The computing device 206 may send the notification to a user device and/or the network device 204. The notification may indicate that the battery of the battery powered devices 202 needs to be replaced. The notification may indicate the remaining battery life of the battery powered devices 202. For example, the computing device 206 may send a notification to a user device when the remaining power amount of the battery satisfies a threshold. The threshold may indicate a remaining life of the battery. The threshold may be based on the voltage of the battery, a remaining capacity of the battery, and so forth. When the remaining power amount of the battery satisfies the threshold (e.g., reaches the threshold), the network device 204 may send the notification indicating the remaining power amount of the battery.

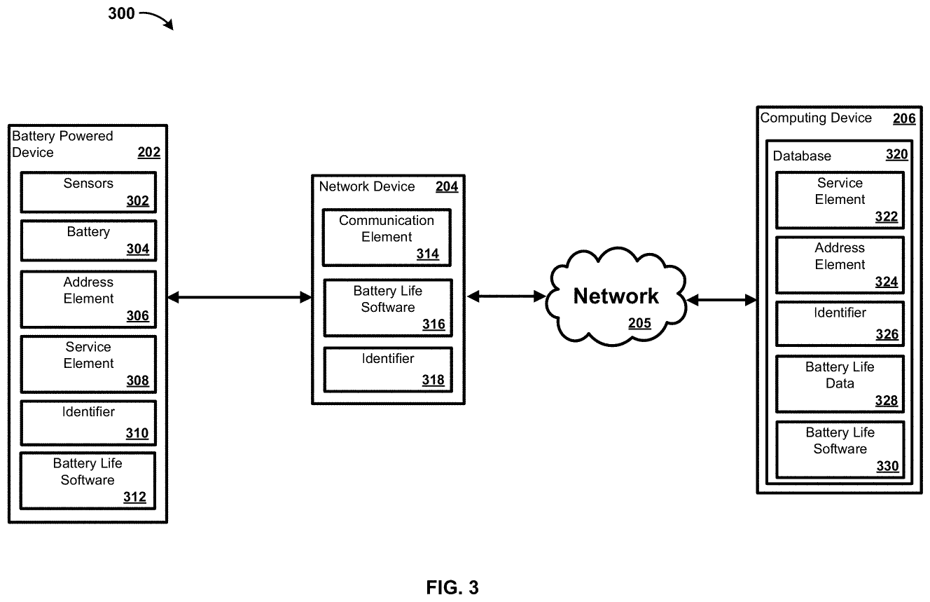

FIG. 3 shows an example system 300 for determining battery life. The system 300 may have a battery powered device 202, a network device 204, and a computing device 206. The network device 204 may facilitate the connection of a device, such as a user device or the battery powered device 202, to a network (e.g., a wireless network).

The battery powered device 202 may have sensors 302, a battery 304, an address element 306, a service element 308, an identifier 310, and battery life software 312. The battery powered device 202 may be an electronic device such as a computer, a smartphone, a laptop, a tablet, a set top box, a display device, or other battery powered device. The battery powered devices 202 may be an Internet of Things (IoT) device such as any low powered electronic device which may comprise a smart device (e.g., a smart thermostat, a home electronic hub, etc.). The battery powered device 202 may be Consumer Premises Equipment (CPE), such as a security system (e.g., electronic camera, smart doorbell, etc.), and so forth.

The battery powered device 202 may have one or more sensors 302 (e.g., the sensors 140 and the battery sensor 195 of FIG. 1). The sensors 302 may be a temperature sensor, a current sensor, a voltage sensor, a resistance sensor, and so forth. The sensors 302 may be configured to determine one or more characteristics associated with the battery 304. For example, the sensors 302 may be configured to measure at least one of a voltage of the battery 304, a resistance of the battery 304, a current associated with the battery 304, and/or a temperature of the battery 304. The sensors 302 may be configured to determine data associated with an environment around the battery powered device 202. For example, the sensors 302 may be configured to measure a temperature of the environment around the battery powered device 202, determine a presence of smoke (e.g., a smoke detector) or another chemical (e.g., natural gas, carbon monoxide, etc.).

The sensors 302 may be configured to detect and/or capture information around the battery powered device 202. For example, the sensors 302 may comprise a camera that is configured to capture still images and/or video around the battery powered device 202. As an example, the battery powered device 202 may be a security camera associated with a security system of a premises (e.g., the premises 210 of FIG. 2). As another example, the battery powered device 202 may be a security device (e.g., a glass break detector, a door open detector, etc.) associated with a security system, and the sensors 302 may capture data that indicates whether security event (e.g., a security breach, a break-in, etc.) is occurring. For example, the sensors 302 may comprise a sound sensor (e.g., a microphone) that captures sound around the battery powered device 202.

The battery powered device 202 may be configured to send a notification associated with the data captured by the sensors 302. The battery powered device 202 may generate the notification based on the presence of an event (e.g., a security event, a fire, presence of a dangerous chemical). The notification may be a communication to another device, an audible alarm, and/or a visual alert. For example, the battery powered device 202 may be a security device that is configured to send a notification upon detecting an event. As an example, the battery powered device 202 may be a door open sensor that may send a notification to another device (e.g., the network device 204, the computing device 206, and/or a user device) to indicate that the door has been opened. As another example,

The battery 304 of the battery powered device 202 may be any type of battery. For example, the battery 304 may be a non-rechargeable battery and/or a rechargeable battery. The battery 304 may be any size and/or type of battery. For example, the battery 304 may be a cylindrical battery (e.g., AAA, C, D, CR2, 2CR5, etc.), a rectangular battery (9 volt, 12 volt, etc.), a button cell battery (e.g., CR927, CR1220, CR2025, etc.), a zinc air cell battery (e.g., AC10, ZA13, A312, etc.), and so forth. The battery 304 may be made of any material such as alkaline, carbon zinc, Lithium-ion (Li-ion), Nickel Cadmium (Ni—Cd), Nickel-Metal Hydride (Ni-MH), Lithium-Manganese Dioxide (LiMnO₂), or any suitable battery.

The battery 304 may have a storage capacity, which is the total amount of power (e.g., charge) that the battery 304 can store. The storage capacity of the battery 304 may or may not change over time. For example, if the battery 304 is a non-rechargeable battery, the storage capacity may not change over time because the capacity is a fixed amount since the battery 304 is not capable of being recharged. As another example, if the battery 304 is a rechargeable battery, the storage capacity of the battery may change over time as the battery 304 is used. For example, as the battery 304 is used (e.g., power is discharged from the battery 304, the battery 304 is charged, etc.), the capacity of the battery 304 may decrease due to the use. Thus, the capacity of the battery 304 may change overtime, which may impact determining the amount of power remaining in the battery 304. Thus, the capacity of the battery 304 may be determined based on one or more characteristics of the battery 304 and/or use of the battery 304 to account for any change in the capacity of the battery 304. Accordingly, the battery powered device 202 may be configured to take into account the change in the capacity of the battery 304 when determining a remaining power left in the battery 304.

The battery 304 may have a battery life associated with the battery 304. For example, the battery 304 may be a rechargeable battery that has a number of usage cycles (e.g., charged and discharged) that the battery 304 can have before the battery is no longer effective (e.g., does not hold a sufficient charge for the battery powered device 202's intended use of the battery 304). As an example, the battery 304 may have a battery life of 10 usage cycles such that the battery 304 may be discharged and charged a total of 10 times before the battery 304 no longer holds a sufficient charge when fully charged due to a diminished capacity of the battery 304. The battery life of the battery 304 may be indicated by a capacity of the battery 304. For example, when the capacity of the rechargeable battery is diminished (e.g., reduced) to the point of no longer being effective for its intended use, the life of the battery 304 may be considered ended even though the battery 304 is still usable because the battery 304 still holds a charge. Thus, when the battery life satisfies a threshold (e.g., when the capacity is reduced to the point that the threshold is satisfied), a notification may be generated and/or sent to indicate that the battery life of the battery 304 is near the end of the effective life of the battery 304, and the battery 304 needs to be replaced. As an example, when the capacity of the battery 304 is reduced to a percentage (e.g., 50%, 60%, 70%, etc.) as compared to the capacity of the battery 304 when new (e.g., 100%), the notification may be generated and/or sent to indicate the that the battery 304 needs to be replaced.

The battery powered device 202 may have an address element 306 and a service element 308. The address element 306 may comprise or provide an internet protocol address, a network address, a media access control (MAC) address, an Internet address, or the like. The address element 306 may be relied upon to establish a communication session between the battery powered device 202 and the network device 204 or other devices and/or networks. The address element 306 may be used as an identifier or locator of the battery powered device 202. The address element 306 may be persistent for a particular network.

The service element 308 may comprise an identification of a service provider associated with the battery powered device 202 and/or with the class of battery powered device 202. The class of the battery powered device 202 may be related to a type of device, capability of device, type of service being provided, and/or a level of service (e.g., business class, service tier, service package, etc.). The service element 308 may comprise information relating to or provided by a communication service provider (e.g., Internet service provider) that is providing or enabling data flow such as communication services and/or security services associated with the battery powered device 202. The service element 308 may comprise information relating to a preferred service provider for one or more particular services relating to the battery powered device 202. The address element 306 may be used to identify or retrieve data from the service element 308, or vice versa. The one or more of the address element 306 and the service element 308 may be stored remotely from the battery powered device 202. Other information may be represented by the service element 308.

The battery powered device 202 may be associated with a user identifier or device identifier 310. The device identifier 310 may be any identifier, token, character, string, or the like, for differentiating one user or computing device (e.g., the battery powered device 202) from another user or computing device. The device identifier 310 may identify a user or computing device as belonging to a particular class of users or computing devices. The device identifier 310 may comprise information relating to the battery powered device 202 such as a manufacturer, a model or type of device, a service provider associated with the battery powered device 202, a state of the battery powered device 202, a locator, and/or a label or classifier. Other information may be represented by the device identifier 310. The device identifier 310 may be assigned to the battery powered device 202 by the network device 204 and/or the computing device 206.

The battery powered device 202 may have battery life software 312. The battery life software 312 may be configured to determine a storage capacity of the battery 304, a battery life of the battery 304, and/or a power usage of the battery powered device 202. The battery life software 312 may be software, firmware, and/or hardware.

The battery life software 312 may determine a power usage of the battery powered device 202. The power usage of the battery powered device 202 may be determined without measuring the power usage of the battery powered device 202. That is, the power usage of battery powered device 202 may be determined by software and/or firmware without using a piece of hardware to determine the power usage of the battery 304. The power usage of the battery powered device 202 may be determined based on an operating state of the battery powered device 202. The operating states of the battery powered device 202 may be determined and/or known, and the power usage for the operating states may be determined and/or known. For example, a manufacturer of the battery powered device 202 may provide information regarding the operating states and/or the power usage of the operating states. As another example, the power usage of the operating states may be previously determined (e.g., measured) for a given battery powered device 202.

The battery life software 312 may determine the operating state of the battery powered device 202. The operating state of the battery powered device 202 may be a sleep state, an awake state, a transmit state, a receive state, a temperature measurement state, or combinations of these states. The power usage of the battery powered device 202 may be determined based on a period of time that the battery powered device 202 is in a given operating state. The battery powered device 202 may have a plurality of operating states, and each operating state may be associated with a different power usage. For example, the sleep state may use 600 nA of current per hour, the awake state may use 12 mA of current per hour, the transmit state may use 145 mA of current per hour, the receive state may use 35 mA per hour, and the temperature measurement state may use 6 μA per hour. The battery powered device 202 may send data associated with the operating states and/or period of times that the battery powered device 202 is in a given operating state to the network device 204 and/or the computing device 206 (e.g., via the network device 204).

The battery life software 312 may determine a period of time that the battery powered device 202 is in each of the different operating states to determine the power usage of the battery powered device 202. For example, the battery life software 312 may multiple the power usage for a given state times the period of time that the battery powered device 202 is in the given state. As an example, if the battery powered device 202 is in the sleep state for 2 hours, the awake state for 30 minutes, and the receive state for 1 hour, the battery life software 312 multiplies power usage of the state (e.g., 600 nAh for the sleep state, 12 mAh for the awake state, and 35 mAh for the receive state) time the period of time that the battery powered device 202 is in the given state. Thus, in this example, the battery life software 312 determines that the battery powered device 202 consumed (e.g., used) 53.7 mAh (e.g., 1.2 mAh for the sleep state for 2 hours, 17.5 mAh for the awake state for 30 minutes, and 35 mAh for the receive state for one hour). Further, the battery life software 312 may determine the power usage of the battery powered device 202 without measuring the power usage since the battery life software 312 calculates the power usage.

The battery life software 312 may determine a storage capacity of the battery 304. The battery life software 312 may determine the storage capacity of the battery 304 based on one or more characteristics of the battery 304. The one or more characteristics of the battery 304 may be at least one of a voltage, a resistance, a current, or a temperature. The battery life software 312 may utilize the sensors 302 to determine the one or more characteristics of the battery 304. The battery life software 312 may utilize the one or more characteristics of the battery 304 to determine a storage capacity of the battery 304. For example, the battery life software 312 may determine an identity of the battery 304. The identity of the battery 304 may indicate a manufacturer of the battery 304, the storage capacity of the battery 304, a type of the battery 304, a life span of the battery 304, a chemical makeup of the battery, and so forth. The identity of the battery 304 may be determined based on the one or more characteristics of the battery 304. For example, the same type of battery (e.g., a AA battery) from different manufacturers will exhibit different characteristics. That is, a AA battery manufactured by a first manufacturer may not have the same characteristics of a AA battery manufactured by a second manufacturer. Additionally, the AA battery may have a different storage capacity between the first and second manufacturer. Accordingly, to accurately determine the storage capacity of the battery 304, the battery life software 312 may need to determine the identity of the battery 304.

The battery life software 312 may determine the identity of the battery 304 by comparing the one or more characteristics of the battery 304 to a plurality of previously identified batteries. For example, one or more characteristics of a plurality of previously identified batteries, including a storage capacity, may have been previously determined, and the battery life software 312 may compare the one or more characteristics of the battery 304 to the plurality of previously identified batteries to determine the identity of the battery 304. As an example, if the one or more characteristics of the battery 304 are within a threshold (e.g., a percentage) of a previously identified battery, the battery 304 may be determined to be the previously identified battery. Thus, the information associated with the previously identified battery may be used to determine any unknown information of the battery 304. That is, the storage capacity of the battery 304 may be determined based on the storage capacity of the previously identified battery. Accordingly, the battery life software 312 may determine the storage capacity of the battery 304 based on the one or more characteristics of the battery 304.

The battery life software 312 may utilize a temperature (e.g., the temperature of the battery 304, the temperature of the environment around the battery powered device 202, etc.) when determining the storage capacity of the battery 304. For example, the characteristics of batteries change based on the temperature of the battery 304. For example, as the temperature of the battery 304 decreases, the resistance of the battery increases. As another example, as the temperature of the battery 304 decreases the voltage output by the battery decreases. Thus, the same battery may have different characteristics based on the temperature of the battery. Further, as the battery 304 is used (e.g., discharges power) the one or more characteristics of the battery 304 may change. As an example, the resistance of the battery 304 increases as the battery is used. As another example, the voltage of the battery 304 decreases as the battery is used. Thus, if the battery life software 312 does not take into account the temperature of the battery 304, the battery life software 312 may not be able to accurately identify the battery 304 because of the change in characteristics. Accordingly, the battery life software 312 may normalize (e.g., take into account temperature) the one or more characteristics of the battery 304 to ensure that the battery life software 312. For example, the battery life software 312 may identify the battery 304 based on the characteristics of the battery 304 at a measured temperature.

The battery life software 312 may determine a remaining power of the battery 304. The battery life software 312 may determine the remaining power of the battery 304 based on the power usage of the battery powered device 202. The battery life software 312 may determine the remaining power of the battery 304 based on the storage capacity of the battery 304. The battery life software 312 may determine the remaining power amount of the battery 304 based on the storage capacity of the battery 304 and the power usage of the battery powered device 202. For example, the battery life software 312 may subtract the determined power usage from the storage capacity of the battery 304 to determine the remaining power amount of the battery 304. Returning to the above example where the battery powered device 202 had a power usage of 53.7 mAh, the battery life software 312 may subtract the power usage from the storage capacity of the battery 304 to determine the remaining power of the battery 304. If the battery 304 has a storage capacity of 1,000 mAh, the battery life software 312 may determine that the battery 304 has 946.3 mAh (e.g., 1,000 mAh-53.7 mAh) of power remaining.

The battery life software 312 may send a notification based on the remaining power amount of the battery 304. For example, the battery life software 312 may send a notification to a user device when the remaining power amount of the battery 304 satisfies a threshold. The threshold may indicate a remaining life of the battery. The threshold may be based on the voltage of the battery, a remaining capacity of the battery, and so forth. When the remaining power amount of the battery 304 satisfies the threshold (e.g., reaches the threshold), the battery life software 312 may send a notification indicating the remaining power amount of the battery 304. For example, the threshold may be satisfied when the remaining power of the battery 304 is 10% of the fully charged power of the battery 304, and the battery life software 312 may send the notification when the remaining power amount of the battery reaches 10%. As an example, if the battery 304 has a storage capacity of 1,000 mAh, the battery life software 312 may send the notification when the battery 304 has 100 mAh of remaining power.

The notification may indicate one or more actions to take based on the remaining power of the battery 304. As an example, the battery life software 312 may send a notification that the battery 304 needs to be replaced because the remaining power amount of the battery 304 is below the threshold. The battery life software 312 may send the notification to another device (e.g., the network device 204, the computing device 206, and/or a user device). As another example, the notification may indicate that the battery 304 needs to be replaced within a period of time (e.g., a week, a month, 6 months, etc.). The period of time may be based on an average power usage of the battery powered device 202. For example, the battery life software 312 may determine an average daily power usage of the battery powered device 202. The average daily power usage may be based on the periods of time that the battery powered device 202 operates in the one or more states of the battery powered device 202. As an example, if the battery powered device 202 uses on average 5 mAh of power a day and the battery 304 has 100 mAh of power remaining, the battery life software 312 may indicate in the notification that the battery powered device 202 will run out of battery within 20 days. Thus, a user of the another device may be provided a more accurate notification than simply a “low battery” warning, which does not indicate the run time left of the battery powered device 202.

The network device 204 may have a communication element 314, battery life software 316, and an identifier 318. The network device 204 may be configured as a local area network (LAN). The network device 204 may be a wireless communication device. The network device 204 may be a gateway device for communicating with another network (e.g., the network 205), such as a communication network provided by an Internet Service Provider. The network device 204 may be configured with a first service set identifier (SSID) (e.g., associated with a user network or private network) to function as a local network for a particular user or users. The network device 204 may be configured with a second SSID (e.g., associated with a public/community network or a hidden network) to function as a secondary network or redundant network for connected communication devices. The network device 204 may be configured to allow one or more wireless devices (e.g., the battery powered device 202, a user device, etc.) to connect to a wired and/or wireless network using Wi-Fi, Bluetooth or any desired method or standard.

The communication element 314 may be a wireless transceiver configured to transmit and receive wireless communications via a wireless communication. The communication element 314 may be configured to communicate via a specific network protocol. The communication element 314 may be a wireless transceiver configured to communicate via a Wi-Fi network. The network device 204 may communicate with the battery powered device 202, the computing device 206, and/or a user device via the communication element 314.

The network device 204 may have an identifier 318. The identifier 318 may be or relate to an Internet Protocol (IP) Address, a Media Access Control (MAC) address, or the like. The identifier 318 may be a unique identifier for facilitating wired and/or wireless communications with the network device 204. The identifier 318 may be associated with a physical location of the network device 204.

The network device 204 may have battery life software 316. The battery life software 316 may comprise all the capabilities of the battery life software 312. For example, the network device 204 may receive data from the battery powered device 202. The data may indicating an operating state of the battery powered device 202, a period of time the battery powered device 202 was in the operating state, a power usage of the battery powered device 202, and so forth. The battery life software 316 may receive the data from the battery powered device 202 (e.g., via the communication element 314) and determine an identity of a battery (e.g., the battery 304) of the battery powered device 202, a storage capacity of the battery, a remaining power of the battery, and so forth. The network device 204 may send a notification to the battery powered device 202 and/or another device (e.g., the computing device 206, a user device, etc.). For example, the network device 204 may send the notification based on determining that the remaining power of the battery of the battery powered device 202 satisfies a threshold.

The computing device 206 may have a database 320, a service element 322, an address element 324, an identifier 326, battery life data 326, and battery life software 328. The computing device 206 may manage the communication between the battery powered device 202 and a database 320 for sending and receiving data therebetween. The database 320 may store a plurality of files (e.g., web pages), user identifiers or records, data associated with a plurality of batteries, and/or other information. The battery powered device 202 and/or the network device 204 may request and/or retrieve a file from the database 320. The database 320 may store information relating to the battery powered device 202 such as the address element 306 and/or the service element 308. The computing device 206 may obtain the device identifier 310 from the battery powered device 202 and retrieve information from the database 320. The computing device 206 may assign the identifier 310 to the battery powered device 202. Any information may be stored in and retrieved from the database 320. The database 320 may be disposed remotely from the computing device 206 and accessed via direct or indirect connection. The database 320 may be integrated with the computing device 206 or some other device or system.

The computing device 206 may have a service element 322. The service element 322 may comprise an identification of a service provider associated with the computing device 206 and/or with the class of computing device 206. The class of the computing device 206 may be related to a type of device, capability of device, type of service being provided, and/or a level of service (e.g., business class, service tier, service package, etc.). The service element 322 may comprise information relating to or provided by a communication service provider (e.g., Internet service provider) that is providing or enabling data flow such as communication services to the computing device 206. The service element 322 may comprise information relating to a preferred service provider for one or more particular services relating to the computing device 206. Other information may be represented by the service element 322.

The address element 324 may comprise or provide an internet protocol address, a network address, a media access control (MAC) address, an Internet address, or the like. The address element 324 may be relied upon to establish a communication session between the computing device 206 and the network device 204 or other devices and/or networks. The address element 324 may be used as an identifier or locator of the computing device 206. The address element 324 may be persistent for a particular network.

The computing device 206 may have an identifier 326. The identifier 326 may be or relate to an Internet Protocol (IP) Address, a Media Access Control (MAC) address, or the like. The identifier 326 may be a unique identifier for facilitating wired and/or wireless communications with the network device 204. The identifier 326 may be associated with a physical location of the computing device 206.

The computing device 206 may store battery life data 328 in the database 320. The battery life data 328 may contain data related to one or more batteries (e.g., the battery 304), as well as data related to the power usage of one or more devices (e.g., the battery powered device 202). The battery life data 328 may facilitate determining an amount of power left in a battery. The battery life data 328 may contain one or more characteristics of the batteries. The one or more characteristics of the battery may be at least one of a voltage, a resistance, a current, a temperature, a quiescent voltage, and/or a voltage during a max load of the battery 304. The battery life data 328 may contain an identity of one or more batteries. The identity of the battery may indicate a manufacturer of the battery, the storage capacity of the battery, a type of the battery, a life span of the battery, and so forth. The battery usage data 328 may be utilized to determine the storage capacity of the battery 304 of the battery powered device 202. For example, the battery usage data 328 may comprise characteristics associated with a plurality of batteries. The computing device 206 may be configured to utilize the characteristics associated with the plurality of batteries to determine a battery that matches (e.g., is the same as, is similar to, etc.) the battery 304. The computing device 206 may determine the storage capacity of the battery 304 based on the battery that matches the battery 304.

The battery life data 328 may comprise data associated with operation of the battery powered device 202. For example, the computing device 206 may receive data form the battery powered device 202 and/or the network device 204 regarding the operating state of the battery powered device 202. The computing device 206 may determine the power usage based on the data. Further, the computing device 206 may determine that the power usage information for the battery powered device is not accurate. For example, if the power usage of battery powered device 202 indicates that the 1,100 mAh of power has been used by the battery powered device 202, but the battery 304 only has a storage capacity of 800 mAh, the power usage calculation for the battery powered device 202 may not be accurate. The computing device 206 may modify the power usage information associated with the battery powered device 202 so that the power usage information more accurately reflects the power used by the battery powered device 202.

The computing device 206 may modify the battery life data 328 based on data provided by the battery powered device 202. For example, if the power usage of battery powered device 202 indicates that the 1,100 mAh of power has been used by the battery powered device 202, but the battery life data 328 indicates that the battery 304 only has a storage capacity of 800 mAh, the storage capacity of the battery 304 may be incorrect. Stated differently, the power usage of the battery powered device 202 may be accurate, but the battery 304 has a larger storage capacity than indicated by the battery life data 328. The computing device 206 may modify the battery life data 328 to adjust the storage capacity of the battery 304 to more accurately reflect the actual storage capacity of the battery 304.

The computing device 206 may have battery life software 330. The battery life software 330 may comprise all the capabilities of the battery life software 312 and/or the battery life software 316. For example, the computing device 206 may receive data from the battery powered device 202 and/or the network device 204. The data may indicating an operating state of the battery powered device 202, a period of time the battery powered device 202 was in the operating state, a power usage of the battery powered device 202, and so forth. The battery life software 330 may receive the data from the battery powered device 202 (e.g., via the network device 204 and the network 205) and determine an identity of a battery (e.g., the battery 304) of the battery powered device 202, a storage capacity of the battery, a remaining power of the battery, and so forth. The computing device 206 may send a notification to the battery powered device 202, the network device 204, and/or another device (e.g., a user device). For example, the computing device 206 may send the notification based on determining that the remaining power of the battery of the battery powered device 202 satisfies a threshold.

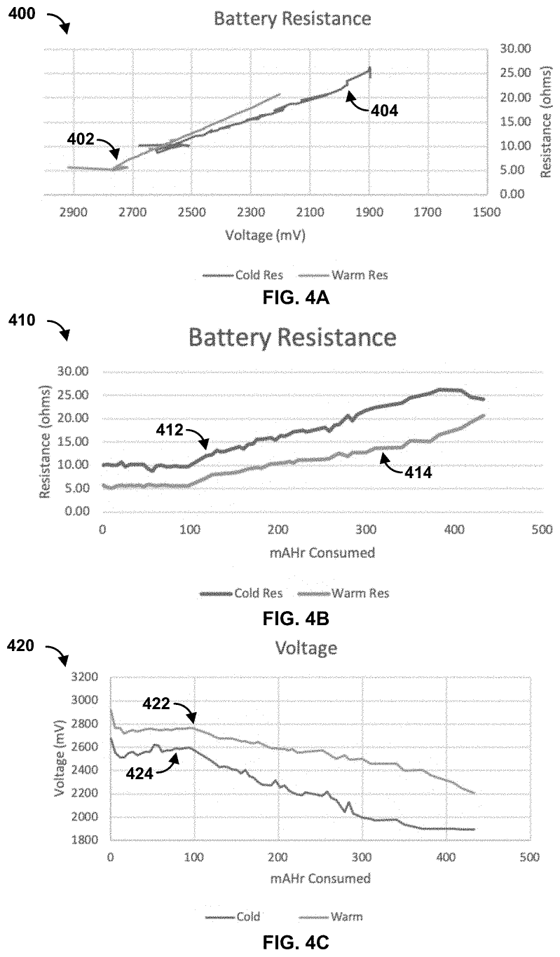

FIGS. 4A-4C show example graphs of characteristics of a battery. FIG. 4A comprises a graph 400 that indicates a change in the resistance of a battery based on a voltage of the battery. As shown, as the voltage of the battery decreases, the resistance of the battery increases. However, the change in voltage and resistance is dependent on temperature. Specifically, the resistance of the battery when warm, as indicated by line 402, starts at approximately 5 SI, and increases up to approximately 20Ω as the voltage of the battery goes from 2900 mV to approximately 2200 mV. In comparison, the resistance of the battery when cold, as indicated by line 404, starts at approximately 10Ω, and increases up to approximately 25Ω as the voltage of the battery goes from 2700 mV to approximately 1900 mV. Thus, the graph 400 indicates how the temperature of the battery impacts the voltage and resistance of the battery.

FIG. 4B comprises a graph 410 that indicates a change in resistance of a battery based on an amount of power consumed from the battery. As shown, as more power is consumed form the (e.g., the remaining power of the battery decreases), the resistance of the battery increases. However, the change in the resistance dependent on temperature. Specifically, the resistance of the battery when warm, as indicated by line 414, starts at approximately 5 SI, and increases up to approximately 20Ω as the power consumed from the battery goes from 0 mAh to approximately 450 mAh. In comparison, the resistance of the battery when cold, as indicated by line 412, starts at approximately 10 SI, and increases up to approximately 25Ω as the power consumed from the battery goes from 0 mAh to approximately 450 mAh. Thus, the graph 410 indicates how the temperature of the battery impacts the resistance of the battery, as well as indicates how the resistance changes based on the power consumed from the battery.

FIG. 4C comprises a graph 420 that indicates a change in voltage of a battery based on an amount of power consumed from the battery. As shown, as more power is consumed form the (e.g., the remaining power of the battery decreases), the voltage of the battery decreases. However, the change in the voltage is dependent on temperature. Specifically, the voltage of the battery when warm, as indicated by line 422, starts at approximately 2900 mV, and drops down to approximately 2200 mV as the power consumed from the battery goes from 0 mAh to approximately 450 mAh. In comparison, the voltage of the battery when cold, as indicated by line 424, starts at approximately 2600 mV, and drops down to approximately 1900 mV as the power consumed from the battery goes from 0 mAh to approximately 450 mAh. Thus, the graph 420 indicates how the temperature of the battery impacts the voltage of the battery, as well as indicates how the voltage changes based on the power consumed from the battery.

The temperature may be taken into account when determining one or more characteristics of the battery. For example, FIG. 4A-4C highlight that a battery may exhibit different characteristics based on the temperature of the battery. Thus, to accurately determine one or more attributes of the battery, such as the capacity of the battery, the battery life of the battery, and/or the remaining life of the battery, the temperature needs to be accounted for in order to normalize the one or more characteristics. Otherwise, the one or more attributes of the battery may not be accurate.

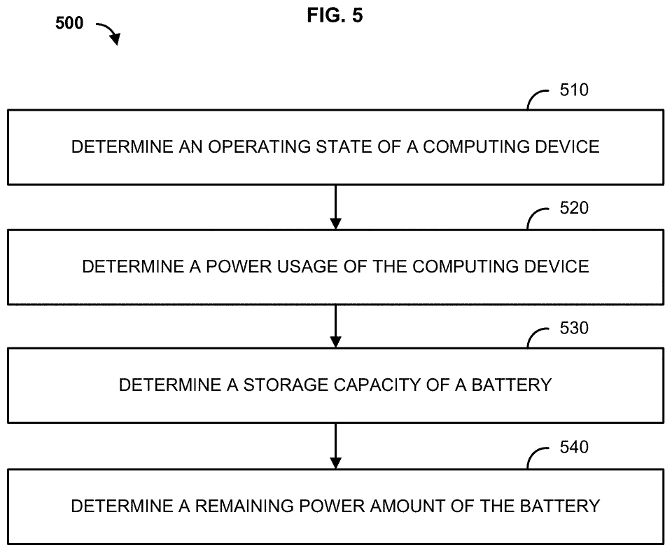

FIG. 5 shows a flowchart of an example method 500 for determining power usage. At step 510, an operating state of a computing device (e.g., the electronic device 101 of FIG. 1, the battery powered device 202 of FIGS. 2 & 3) may be determined. The computing device may be at least one of a smartphone, a laptop, a tablet, a set top box, a display device, a wearable device, Consumer Premises Equipment (CPE), or other battery powered device. Additionally, the computing may be an Internet of Things (IoT) device such as any low powered electronic device which may comprise a smart device (e.g., a smart thermostat, a home electronic hub, etc.). The computing device may be a security system, which may comprise, but is not limited to, an electronic camera, a smart doorbell, a glass break sensor, a motion sensor, a window and/or door open sensor, and so forth. The computing device may determine the operating state of the computing device. The operating state of the computing device may be at least one of a sleep state, a charge state, an awake state, a transmit state, a receive state, a sensor active state, a sensor inactive state, or combinations of these states. Additionally, the operating state of the computing device may comprise a use state that comprises any usage of one or more of software and/or firmware associated with the computing device. For example, the computing device may have one or more applications installed on the computing device that each may be used (e.g., run) by a user of the computing device. Each of the operating states of the computing device may use different amounts of current. The operating states may each have a respective current draw, and one or more of the operating states may not have a current draw. The use state of the computing device may have different current draw based on the quantity of applications running on the computing device. Each application may have an associated current draw associated with being run by the computing device. The use state may comprise the current draw for each of the applications being run on the computing device, and each of the applications may have a respective current draw. Additionally, the current draw of the applications may vary based on how the applications are used. The computing device may monitor the current draw for each application during the use state to determine the individual current draw for each application, as well as the total (e.g., a summation of the current draw for each application) current usage during the use state.

At step 520, a power usage of the computing device may be determined. The power usage of the computing device may be determined based on the operating state of the computing device. The power usage of the computing device may be determined based on a period of time that the computing device is in the operating state. The power usage of the computing device may be determined without measuring the power usage of the computing device. The computing device may send the power usage of the computing device to a network device (e.g., the network device 204 of FIGS. 2 & 3).

At step 530, a storage capacity of a battery may be determined. The storage capacity of the battery may be determined by the computing device. For example, the computing device may be pre-programmed with the capacity of the battery. As another example, the computing device may receive (e.g., from another device) information (e.g., data) that indicates the capacity of the battery. As a further example, the computing device may determine the storage capacity of the battery based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The computing device may send the one or more characteristics of the battery to the network device. The computing device may receive the storage capacity from the network device.

At step 540, a remaining power amount of the battery may be determined. The computing device may determine the remaining power amount of the battery based on the power usage of the computing device. The computing device may determine the remaining power amount of the battery based on the storage capacity of the battery. The computing device may determine the remaining power amount of the battery based on the storage capacity of the battery and the power usage of the computing device. The computing device may subtract the determined power usage from the storage capacity of the battery to determine the remaining power amount of the battery.

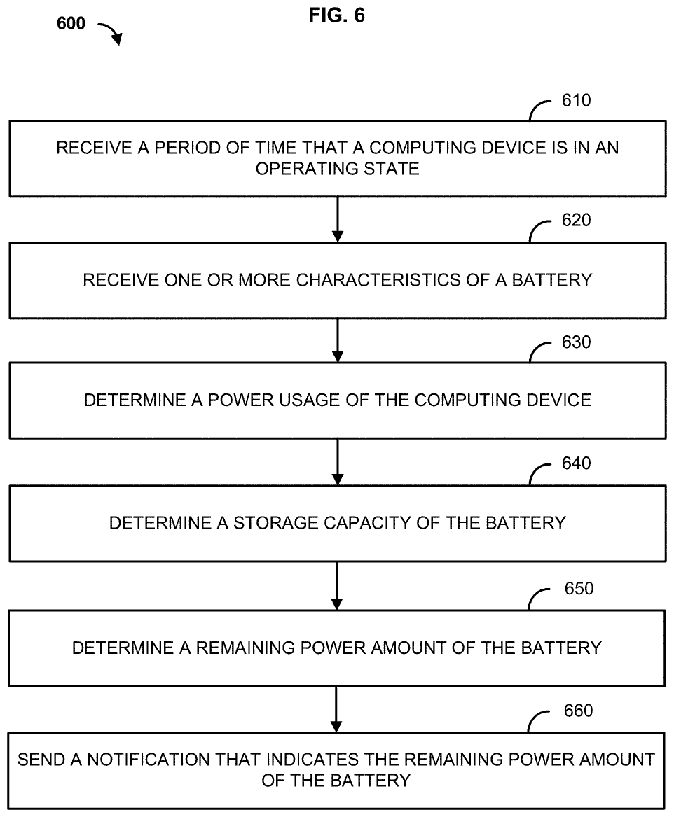

FIG. 6 shows a flowchart of an example method 600 for determining power usage. At step 610, a period of time that a computing device (e.g., the electronic device 101 of FIG. 1, the battery powered device 202 of FIGS. 2 & 3) is in an operating state may be received by a network device (e.g., the network device 204 of FIGS. 2 & 3). For example, data may be received that indicates the period of time that the computing device is/was in the operating state. The computing device may send information that indicates the operating state of the computing device to the network device. The computing device may determine the operating state of the computing device. The operating state of the computing device may be at least one of a sleep state, an awake state, a transmit state, or a receive state. The computing device may be at least one of an Internet of Things (IoT) device, a Consumer Premises Equipment (CPE) device, or a security device.

At step 620, one or more characteristics of a battery may be received. The one or more characteristics of the battery may be received from the computing device. For example, data may be received from the computing device that indicates the one or more characteristics of the battery. The battery may be associated with the computing device. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The identity of the battery may be determined by the network device. The identity of the battery may be determined based on the one or more characteristics of the battery. The computing device may send the one or more characteristics of the battery to the network device. The computing device may receive the storage capacity from the network device. The storage capacity of the battery may be determined by the network device. The network device may determine the storage capacity of the battery based on one or more characteristics of the battery.

At step 630, a power usage of the computing device may be determined. The power usage of the computing device may be determined based on the operating state of the computing device. The power usage of the computing device may be determined based on a period of time that the computing device is in the operating state. The power usage of the computing device may be determined without measuring the power usage of the computing device. The network device may determine the power usage of the computing device.

At step 640, a storage capacity of the battery may be determined. The storage capacity of the battery may be determined by the network device. For example, the network device may be pre-programmed with the capacity of the battery. As another example, the network device may receive (e.g., from another device) information (e.g., data) that indicates the capacity of the battery. As a further example, the network device may determine the storage capacity of the battery based on one or more characteristics of the battery. The network device may determine the storage capacity of the battery based on one or more characteristics of the battery. The network device may receive the one or more characteristics of the battery from the computing device. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The network device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The network device may send the storage capacity to the computing device.

At step 650, a remaining power amount of the battery may be determined. The computing device may determine the remaining power amount of the battery based on the power usage of the computing device. The computing device may determine the remaining power amount of the battery based on the storage capacity of the battery. The computing device may determine the remaining power amount of the battery based on the storage capacity of the battery and the power usage of the computing device. The computing device may subtract the determined power usage from the storage capacity of the battery to determine the remaining power amount of the battery.

At step 660, a notification that indicates the remaining power amount of the battery may be sent. The network device may send the notification and/or the computing device may send the notification. The network device may send notification to the computing device. The network device may send the notification to a user device. The notification may indicate that the battery of the computing device needs to be replaced. The notification may indicate the remaining battery life of the computing device.

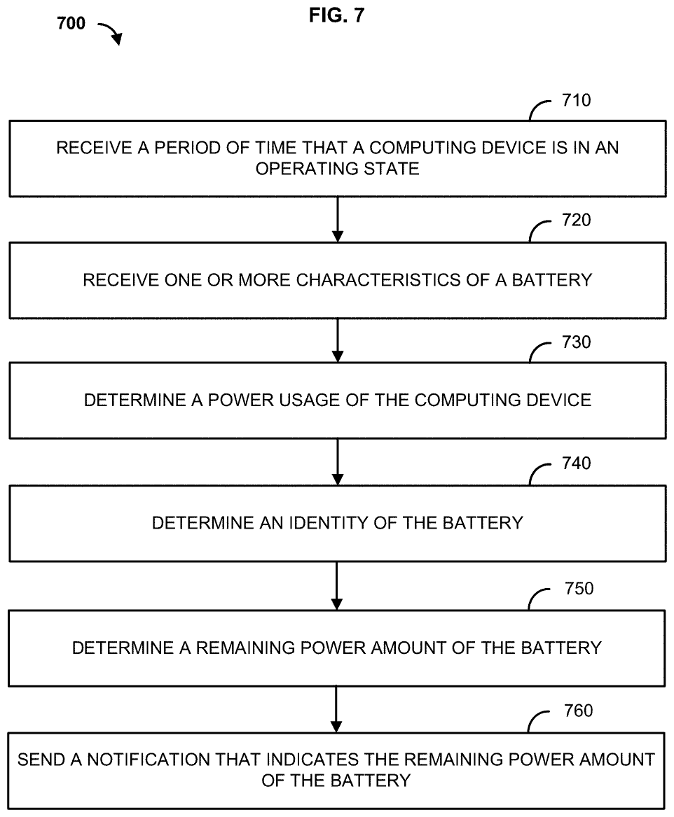

FIG. 7 shows a flowchart of an example method 700 for determining power usage. At step 710, a period of time that a first computing device (e.g., the electronic device 101 of FIG. 1, the battery powered device 202 of FIGS. 2 & 3) is in an operating state may be received by a second computing device (e.g., the computing device 206 of FIGS. 2 & 3). The first computing device may determine the operating state of the first computing device and send the operating state to the second computing device. For example, data may be received by the second computing device that indicates the period of time that the first computing device is/was in the operating state. The operating state of the first computing device may be at least one of a sleep state, a charge state, an awake state, a transmit state, a receive state, a sensor active state, a sensor inactive state, or combinations of these states. Additionally, the operating state of the first computing device may comprise a use state that comprises any usage of one or more of software and/or firmware associated with the computing device. For example, the first computing device may have one or more applications installed on the computing device that each may be used (e.g., run) by a user of the first computing device. Each of the operating states of the first computing device may use different amounts of current. The operating states may each have a respective current draw, and one or more of the operating states may not have a current draw. The use state of the first computing device may have different current draw based on the quantity of applications running on the first computing device. Each application may have an associated current draw associated with being run by the first computing device. The use state may comprise the current draw for each of the applications being run on the first computing device, and each of the applications may have a respective current draw. Additionally, the current draw of the applications may vary based on how the applications are used. The first computing device may monitor the current draw for each application during the use state to determine the individual current draw for each application, as well as the total (e.g., a summation of the current draw for each application) current usage during the use state.

At step 720, one or more characteristics of a battery may be received. The second computing device may receive the one or more characteristics of the battery from the first computing device. For example, data may be received by the second computing device from the first computing device that indicates the one or more characteristics of the battery. The battery may be associated with the first computing device. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The identity of the battery may be determined based on the one or more characteristics of the battery. The first computing device may send the one or more characteristics of the battery to the second computing device. The first computing device may receive the storage capacity from the second computing device.

At step 730, a power usage of the first computing device may be determined. The power usage of the first computing device may be determined based on the operating state of the first computing device. The power usage of the first computing device may be determined based on a period of time that the first computing device is in the operating state. The power usage of the first computing device may be determined without measuring the power usage of the first computing device.

At step 740, an identity of the battery may be determined. The identity of the battery may be determined based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth.

At step 750, a remaining power amount of the battery may be determined. The remaining power amount of the battery may be determined by the second computing device. The second computing device may determine the remaining power amount of the battery based on the power usage of the computing device. The second computing device may determine the remaining power amount of the battery based on the identity of the battery. The second computing device may determine the remaining power amount of the battery based on the identity of the battery and based on the power usage of the first computing device. The second computing device may determine the remaining power amount of the battery based on the storage capacity of the battery. The second computing device may determine the remaining power amount of the battery based on the storage capacity of the battery and the power usage of the first computing device.

At step 760, a notification that indicates the remaining power amount of the battery may be sent. The second computing device may send the notification. The second computing device may send notification to the first computing device. The second computing device may send the notification to a user device. The notification may indicate that the battery of the first computing device needs to be replaced. The notification may indicate the remaining battery life of the first computing device.

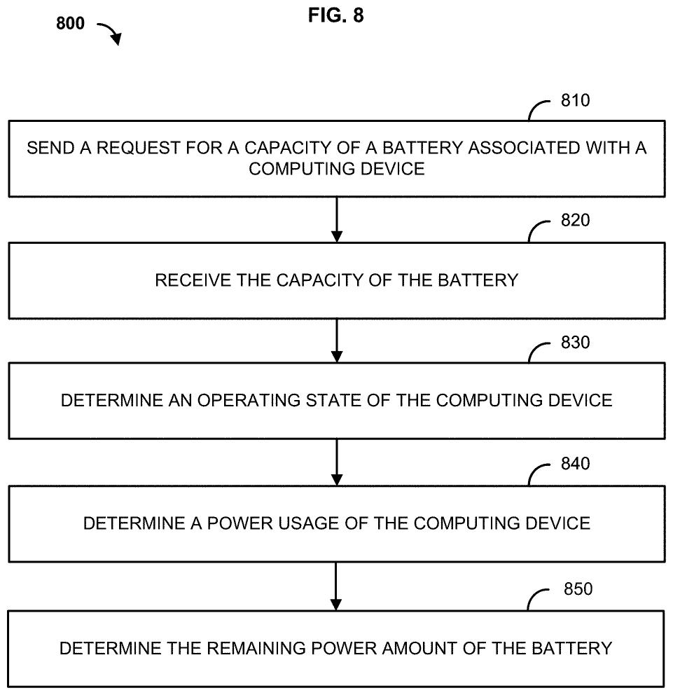

FIG. 8 shows a flowchart of an example method 800 for determining power usage. At step 810, a request for a capacity of a battery associated with a first computing device (e.g., the electronic device 101 of FIG. 1, the battery powered device 202 of FIGS. 2 & 3) is sent. The first computing device may send the request to a second computing device (e.g., the computing device 206 of FIGS. 2 & 3). The request may comprise one or more characteristics of the battery. For example, the request may comprise data that indicates the one or more characteristics of the battery. The second computing device may determine the storage capacity of the battery based on the one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes of the battery, such as a manufacturer of the battery, a storage capacity of the battery, a type of the battery, a battery life (e.g. life span) of the battery, a chemical makeup of the battery, and so forth.

At step 820, the capacity of the battery is received. The first computing device may receive the capacity of the battery from the second computing device. For example, the first computing device may receive data from the second computing device that indicates the capacity of the battery. The second computing device may send the capacity of the battery to the first computing device.

At step 830, an operating state of the first computing device may be determined. The first computing device may determine the operating state of the first computing device. The operating state of the first computing device may be at least one of a sleep state, a charge state, an awake state, a transmit state, a receive state, a sensor active state, a sensor inactive state, or combinations of these states. Additionally, the operating state of the first computing device may comprise a use state that comprises any usage of one or more of software and/or firmware associated with the computing device. For example, the first computing device may have one or more applications installed on the first computing device that each may be used (e.g., run) by a user of the first computing device. Each of the operating states of the first computing device may use different amounts of current. The operating states may each have a respective current draw, and one or more of the operating states may not have a current draw. The use state of the first computing device may have different current draw based on the quantity of applications running on the first computing device. Each application may have an associated current draw associated with being run by the first computing device. The use state may comprise the current draw for each of the applications being run on the first computing device, and each of the applications may have a respective current draw. Additionally, the current draw of the applications may vary based on how the applications are used. The first computing device may monitor the current draw for each application during the use state to determine the individual current draw for each application, as well as the total (e.g., a summation of the current draw for each application) current usage during the use state.

At step 840, a power usage of the first computing device is determined. The power usage of the first computing device may be determined based on the operating state of the first computing device. The power usage of the first computing device may be determined based on a period of time that the first computing device is in the operating state. The power usage of the first computing device may be determined without measuring the power usage of the first computing device.

At step 850, a remaining power amount of the battery may be determined. The first computing device may determine the remaining power amount of the battery based on the power usage of the first computing device. The first computing device may determine the remaining power amount of the battery based on the storage capacity of the battery. The first computing device may determine the remaining power amount of the battery based on the storage capacity of the battery and the power usage of the first computing device. The first computing device may subtract the determined power usage from the storage capacity of the battery to determine the remaining power amount of the battery.

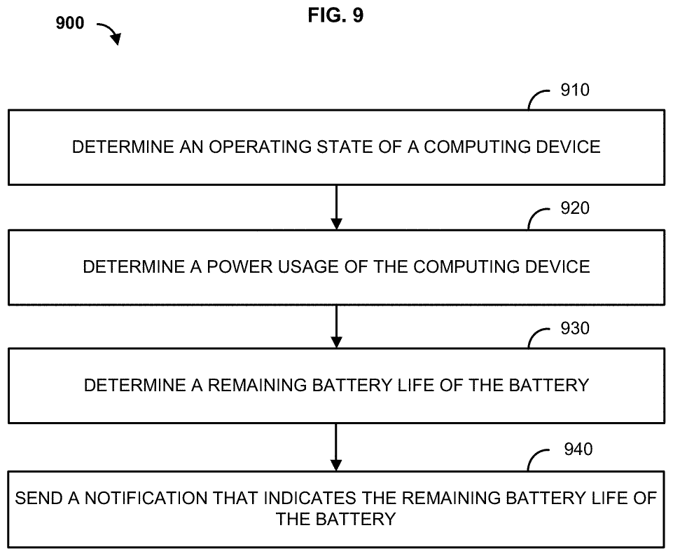

FIG. 9 shows a flowchart of an example method 900 for determining battery life. At step 910, an operating state of a computing device (e.g., the electronic device 101 of FIG. 1, the battery powered device 202 of FIGS. 2 & 3) may be determined. The computing device may be at least one of a smartphone, a laptop, a tablet, a set top box, a display device, a wearable device, or other battery powered device. Additionally, the computing may be an Internet of Things (IoT) device such as any low powered electronic device which may comprise a smart device (e.g., a smart thermostat, a home electronic hub, etc.). The computing device may be Consumer Premises Equipment (CPE), such as a security system (e.g., electronic camera, smart doorbell, glass break sensor, motion sensor, window and/or door open sensor, etc.), and so forth. The computing device may determine the operating state of the computing device. The operating state of the computing device may be at least one of a sleep state, a charge state, an awake state, a transmit state, a receive state, a sensor active state, a sensor inactive state, or combinations of these states. Additionally, the operating state of the computing device may comprise a use state that comprises any usage of one or more of software and/or firmware associated with the computing device. For example, the computing device may have one or more applications installed on the computing device that each may be used (e.g., run) by a user of the computing device. Each of the operating states of the computing device may use different amounts of current. The operating states may each have a respective current draw, and one or more of the operating states may not have a current draw. The use state of the computing device may have different current draw based on the quantity of applications running on the computing device. Each application may have an associated current draw associated with being run by the computing device. The use state may comprise the current draw for each of the applications being run on the computing device, and each of the applications may have a respective current draw. Additionally, the current draw of the applications may vary based on how the applications are used. The computing device may monitor the current draw for each application during the use state to determine the individual current draw for each application, as well as the total (e.g., a summation of the current draw for each application) current usage during the use state.

At step 920, a power usage of the computing device may be determined. The power usage of the computing device may be determined based on the operating state of the computing device. The power usage of the computing device may be determined based on a period of time that the computing device is in the operating state. The power usage of the computing device may be determined without measuring the power usage of the computing device. The computing device may send the power usage of the computing device to a network device (e.g., the network device 204 of FIGS. 2 & 3).

At step 930, a remaining battery life of a battery may be determined. The battery may be a rechargeable battery that has a number of usage cycles (e.g., charged and discharged) that the battery can have before the battery is no longer effective (e.g., does not hold a sufficient charge for the computing device's intended use of the battery). As an example, the battery may have a battery life of 10 usage cycles such that the battery may be discharged and charged a total of 10 times before the battery no longer holds a sufficient charge when fully charged due to a diminished capacity of the battery. The battery life of the battery may be indicated by a capacity of the battery. For example, when the capacity of the rechargeable battery is diminished (e.g., reduced) to the point of no longer being effective for its intended use, the life of the battery may be considered ended even though the battery is still usable because the battery still holds a charge.

The remaining battery life may be determined based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The computing device may send the one or more characteristics of the battery to the network device. The computing device may receive the storage capacity from the network device.

At step 940, a notification that indicates that remaining battery life of the battery is sent. The computing device may send the notification to the network device. The network device may send the notification to a user device. The notification may indicate that the remaining battery life satisfies a threshold that indicates that battery of the computing device needs to be replaced. The threshold may be satisfied when the capacity of the battery is reduced to a percentage (e.g., 50%, 60%, 70%, etc.) as compared to the capacity of the battery when new (e.g., 100%).

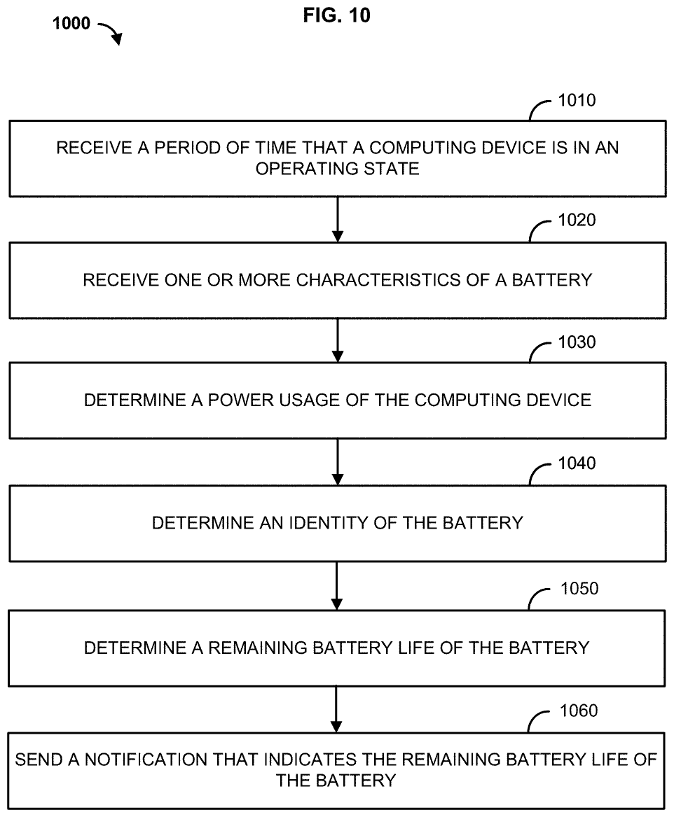

FIG. 10 shows a flowchart of an example method 1000 for determining battery life. At step 1010, a period of time that a first computing device (e.g., the electronic device 101 of FIG. 1, the battery powered device 202 of FIGS. 2 & 3) is in an operating state may be received by a second computing device (e.g., the computing device 206 of FIGS. 2 & 3). For example, data may be received by the second computing device that indicates the period of time that the first computing device is/was in the operating state. The first computing device may determine the operating state of the first computing device and send the operating state to the second computing device. The operating state of the first computing device may be at least one of a sleep state, a charge state, an awake state, a transmit state, a receive state, a sensor active state, a sensor inactive state, or combinations of these states. Additionally, the operating state of the first computing device may comprise a use state that comprises any usage of one or more of software and/or firmware associated with the computing device. For example, the first computing device may have one or more applications installed on the computing device that each may be used (e.g., run) by a user of the first computing device. Each of the operating states of the first computing device may use different amounts of current. The operating states may each have a respective current draw, and one or more of the operating states may not have a current draw. The use state of the first computing device may have different current draw based on the quantity of applications running on the first computing device. Each application may have an associated current draw associated with being run by the first computing device. The use state may comprise the current draw for each of the applications being run on the first computing device, and each of the applications may have a respective current draw. Additionally, the current draw of the applications may vary based on how the applications are used. The first computing device may monitor the current draw for each application during the use state to determine the individual current draw for each application, as well as the total (e.g., a summation of the current draw for each application) current usage during the use state.

At step 1020, one or more characteristics of a battery may be received. The second computing device may receive the one or more characteristics of the battery from the first computing device. For example, data may be received from the first computing device that indicates the one or more characteristics of the battery. The battery may be associated with the first computing device. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The identity of the battery may be determined based on the one or more characteristics of the battery. The first computing device may send the one or more characteristics of the battery to the second computing device. The first computing device may receive the storage capacity from the second computing device.

At step 1040, an identity of the battery may be determined. The identity of the battery may be determined based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth.

At step 1050, a remaining battery life of a battery may be determined. The battery may be a rechargeable battery that has a number of usage cycles (e.g., charged and discharged) that the battery can have before the battery is no longer effective (e.g., does not hold a sufficient charge for the first computing device's intended use of the battery). As an example, the battery may have a battery life of 10 usage cycles such that the battery may be discharged and charged a total of 10 times before the battery no longer holds a sufficient charge when fully charged due to a diminished capacity of the battery. The battery life of the battery may be indicated by a capacity of the battery. For example, when the capacity of the rechargeable battery is diminished (e.g., reduced) to the point of no longer being effective for its intended use, the life of the battery may be considered ended even though the battery is still usable because the battery still holds a charge.

The remaining battery life may be determined based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery.

At step 1060, a notification that indicates that remaining battery life of the battery is sent. The second computing device may send the notification. The second computing device may send the notification to the first computing device. The second computing device may send the notification to a user device. The notification may indicate that the remaining battery life satisfies a threshold that indicates that battery of the first computing device needs to be replaced. The threshold may be satisfied when the capacity of the battery is reduced to a percentage (e.g., 50%, 60%, 70%, etc.) as compared to the capacity of the battery when new (e.g., 100%).

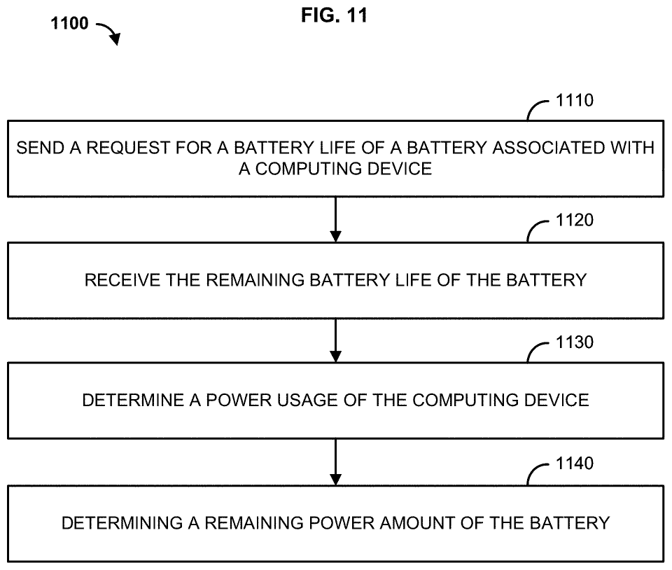

FIG. 11 shows a flowchart of an example method 1100 for determining battery life. At step 1110, a request for a battery life of a battery associated with a first computing device (e.g., the electronic device 101 of FIG. 1, the battery powered device 202 of FIGS. 2 & 3) is sent. The first computing device may send the request to a second computing device (e.g., the computing device 206 of FIGS. 2 & 3). The request may comprise one or more characteristics of the battery. For example, the request may comprise data that indicates the one or more characteristics of the battery. The second computing device may determine the remaining battery life of the battery based on the one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes of the battery, such as a manufacturer of the battery, a storage capacity of the battery, a type of the battery, a battery life (e.g. life span) of the battery, a chemical makeup of the battery, and so forth.

At step 1120, the remaining battery life of the battery is received. The first computing device may receive the remaining battery life of the battery from the second computing device. For example, the first computing device may receive data from the second computing device that indicates the capacity of the battery. The second computing device may send the remaining battery life of the battery to the first computing device.

At step 1130, a power usage of the first computing device is determined. The power usage of the first computing device may be determined based on the operating state of the first computing device. The power usage of the first computing device may be determined based on a period of time that the first computing device is in the operating state. The power usage of the first computing device may be determined without measuring the power usage of the first computing device.

At step 1140, a remaining power amount of the battery may be determined. The first computing device may determine the remaining power amount of the battery based on the power usage of the first computing device. The first computing device may determine the remaining power amount of the battery based on the remaining battery life of the battery. The first computing device may determine the remaining power amount of the battery based on the remaining battery life of the battery and the power usage of the first computing device. The first computing device may subtract the determined power usage from a storage capacity of the battery based on the remaining battery life of the battery to determine the remaining power amount of the battery.

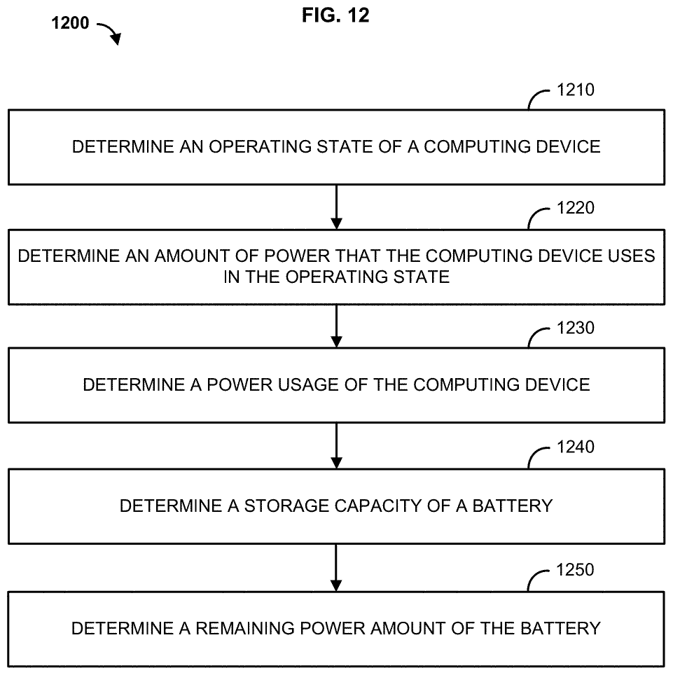

FIG. 12 shows a flowchart of an example method 1200 for determining power usage. At step 1210, an operating state of a computing device (e.g., the electronic device 101 of FIG. 1, the battery powered device 202 of FIGS. 2 & 3) may be determined. The computing device may be at least one of a smartphone, a laptop, a tablet, a set top box, a display device, a wearable device, Consumer Premises Equipment (CPE), or other battery powered device. Additionally, the computing may be an Internet of Things (IoT) device such as any low powered electronic device which may comprise a smart device (e.g., a smart thermostat, a home electronic hub, etc.). The computing device may be a security system, which may comprise, but is not limited to, an electronic camera, a smart doorbell, a glass break sensor, a motion sensor, a window and/or door open sensor, and so forth.

The computing device may determine the operating state of the computing device. The operating state of the computing device may be at least one of a sleep state, a charge state, an awake state, a transmit state, a receive state, a sensor active state, a sensor inactive state, or combinations of these states. Additionally, the operating state of the computing device may comprise a use state that comprises any usage of one or more of software and/or firmware associated with the computing device. For example, the computing device may have one or more applications installed on the computing device that each may be used (e.g., run) by a user of the computing device.

At step 1220, an amount of power that the computing device uses in the operating state is determined. For example, the computing device may use a known quantity of power in given operating state, and the quantity of power used may be known for each of the operating states of the computing device. The known quantity of power may be stored in memory that the computing device utilizes to determine the amount of power used. Each of the operating states of the computing device may use different amounts of current and/or power. The operating states may each have a respective current draw and/or power usage, and one or more of the operating states may not have a current draw and/or power usage. The use state of the computing device may have different current draws and/or power usage based on the quantity of applications running on the computing device. Each application may have an associated current draw and/or power usage associated with being run by the computing device. The use state may comprise the current draw and/or power usage for each of the applications being run on the computing device, and each of the applications may have a respective current draw and/or power usage. Additionally, the current draw and/or power usage of the applications may vary based on how the applications are used. The computing device may monitor the current draw and/or power usage for each application during the use state to determine the individual current draw for each application, as well as the total (e.g., a summation of the current draw for each application) current usage and/or power usage during the use state.

At step 1230, a power usage of the computing device may be determined. The power usage of the computing device may be determined based on the operating state of the computing device and based on the amount of power that the computing device uses in the operating state. The power usage of the computing device may be determined based on a period of time that the computing device is in the operating state. The power usage of the computing device may be determined without physically measuring the power usage of the computing device. The computing device may send the power usage of the computing device to a network device (e.g., the network device 204 of FIGS. 2 & 3).

At step 1240, a storage capacity of a battery may be determined. The storage capacity of the battery may be determined by the computing device. For example, the computing device may be pre-programmed with the capacity of the battery. As another example, the computing device may receive (e.g., from another device) information (e.g., data) that indicates the capacity of the battery. As a further example, the computing device may determine the storage capacity of the battery based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The computing device may send the one or more characteristics of the battery to the network device. The computing device may receive the storage capacity from the network device.

At step 1250, a remaining power amount of the battery may be determined. The computing device may determine the remaining power amount of the battery based on the power usage of the computing device. The computing device may determine the remaining power amount of the battery based on the storage capacity of the battery. The computing device may determine the remaining power amount of the battery based on the storage capacity of the battery and the power usage of the computing device. The computing device may subtract the determined power usage from the storage capacity of the battery to determine the remaining power amount of the battery.

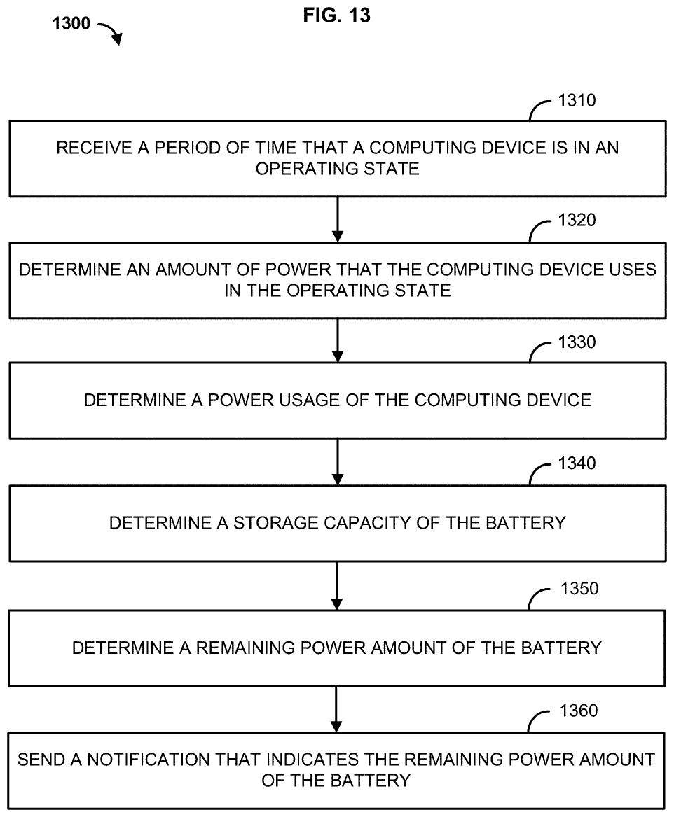

FIG. 13 shows a flowchart of an example method 1300 for determining power usage. At step 1310, a period of time that a computing device (e.g., the electronic device 101 of FIG. 1, the battery powered device 202 of FIGS. 2 & 3) is in an operating state may be received by a network device (e.g., the network device 204 of FIGS. 2 & 3). For example, data may be received that indicates the period of time that the computing device is/was in the operating state. The computing device may send information that indicates the operating state of the computing device to the network device. The computing device may determine the operating state of the computing device. The operating state of the computing device may be at least one of a sleep state, an awake state, a transmit state, or a receive state. The computing device may be at least one of an Internet of Things (IoT) device, a Consumer Premises Equipment (CPE) device, or a security device.

At step 1320, an amount of power that the computing device uses in the operating state is determined. For example, the computing device may use a known quantity of power in given operating state, and the quantity of power used may be known for each of the operating states of the computing device. The known quantity of power may be stored in memory that the computing device utilizes to determine the amount of power used. Each of the operating states of the computing device may use different amounts of current and/or power. The operating states may each have a respective current draw and/or power usage, and one or more of the operating states may not have a current draw and/or power usage. The use state of the computing device may have different current draws and/or power usage based on the quantity of applications running on the computing device. Each application may have an associated current draw and/or power usage associated with being run by the computing device. The use state may comprise the current draw and/or power usage for each of the applications being run on the computing device, and each of the applications may have a respective current draw and/or power usage. Additionally, the current draw and/or power usage of the applications may vary based on how the applications are used. The computing device may monitor the current draw and/or power usage for each application during the use state to determine the individual current draw for each application, as well as the total (e.g., a summation of the current draw for each application) current usage and/or power usage during the use state.

At step 1330, a power usage of the computing device may be determined. The power usage of the computing device may be determined based on the operating state of the computing device and based on the amount of power that the computing device uses in the operating state. The power usage of the computing device may be determined based on a period of time that the computing device is in the operating state. The power usage of the computing device may be determined without physically measuring the power usage of the computing device. The network device may determine the power usage of the computing device.

At step 1340, a storage capacity of the battery may be determined. The storage capacity of the battery may be determined by the network device. For example, the network device may be pre-programmed with the capacity of the battery. As another example, the network device may receive (e.g., from another device) information (e.g., data) that indicates the capacity of the battery. As a further example, the network device may determine the storage capacity of the battery based on one or more characteristics of the battery. The network device may determine the storage capacity of the battery based on one or more characteristics of the battery. The network device may receive the one or more characteristics of the battery from the computing device. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The network device may determine the identity of the battery to determine one or more attributes about the battery, such as a manufacturer of the battery, a storage capacity of the battery, a type of the battery, a battery life (e.g. life span) of the battery, a chemical makeup of the battery, and so forth. The network device may send the storage capacity to the computing device.

At step 1350, a remaining power amount of the battery may be determined. The computing device may determine the remaining power amount of the battery based on the power usage of the computing device. The computing device may determine the remaining power amount of the battery based on the storage capacity of the battery. The computing device may determine the remaining power amount of the battery based on the storage capacity of the battery and the power usage of the computing device. The computing device may subtract the determined power usage from the storage capacity of the battery to determine the remaining power amount of the battery.

At step 1360, a notification that indicates the remaining power amount of the battery may be sent. The network device may send the notification and/or the computing device may send the notification. The network device may send notification to the computing device. The network device may send the notification to a user device. The notification may indicate that the battery of the computing device needs to be replaced. The notification may indicate the remaining battery life of the computing device.

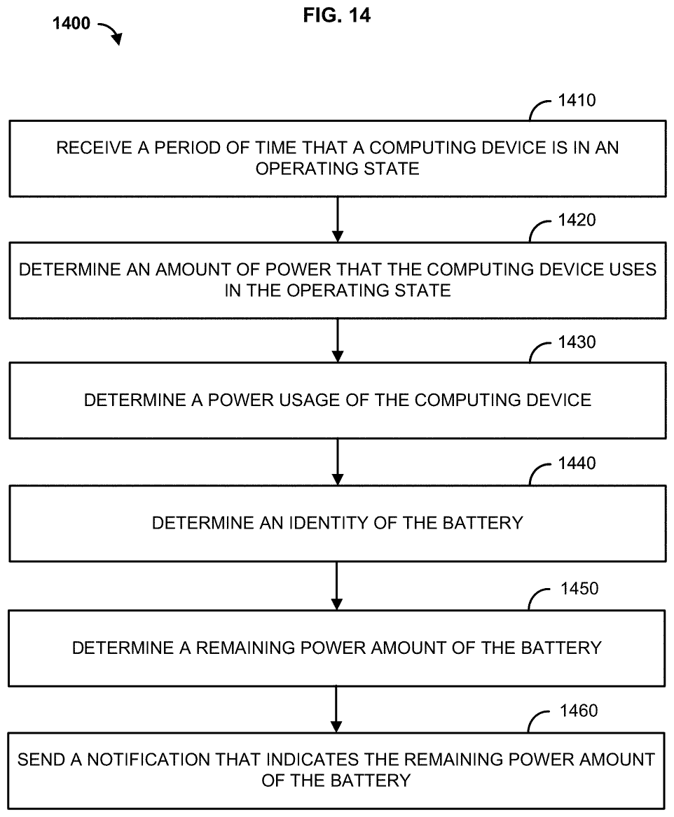

FIG. 14 shows a flowchart of an example method 1400 for determining power usage. At step 1410, a period of time that a first computing device (e.g., the electronic device 101 of FIG. 1, the battery powered device 202 of FIGS. 2 & 3) is in an operating state may be received by a second computing device (e.g., the computing device 206 of FIGS. 2 & 3). The first computing device may determine the operating state of the first computing device and send the operating state to the second computing device. For example, data may be received by the second computing device that indicates the period of time that the first computing device is/was in the operating state. The operating state of the first computing device may be at least one of a sleep state, a charge state, an awake state, a transmit state, a receive state, a sensor active state, a sensor inactive state, or combinations of these states. Additionally, the operating state of the first computing device may comprise a use state that comprises any usage of one or more of software and/or firmware associated with the computing device. For example, the first computing device may have one or more applications installed on the computing device that each may be used (e.g., run) by a user of the first computing device.

At step 1420, an amount of power that the second computing device uses in the operating state is determined. For example, the second computing device may use a known quantity of power in given operating state, and the quantity of power used may be known for each of the operating states of the second computing device. The known quantity of power may be stored in memory that at least one of the first computing device or the second computing device utilizes to determine the amount of power used. Each of the operating states of the second computing device may use different amounts of current and/or power. The operating states may each have a respective current draw and/or power usage, and one or more of the operating states may not have a current draw and/or power usage. The use state of the second computing device may have different current draws and/or power usage based on the quantity of applications running on the second computing device. Each application may have an associated current draw and/or power usage associated with being run by the second computing device. The use state may comprise the current draw and/or power usage for each of the applications being run on the second computing device, and each of the applications may have a respective current draw and/or power usage. Additionally, the current draw and/or power usage of the applications may vary based on how the applications are used. The first computing device and/or the second computing device may monitor the current draw and/or power usage for each application during the use state to determine the individual current draw for each application, as well as the total (e.g., a summation of the current draw for each application) current usage and/or power usage during the use state.

At step 1430, a power usage of the first computing device may be determined. The power usage of the first computing device may be determined based on the operating state of the first computing device. The power usage of the first computing device may be determined based on a period of time that the first computing device is in the operating state. The power usage of the first computing device may be determined without physically measuring the power usage of the first computing device.

At step 1440, an identity of the battery may be determined. The identity of the battery may be determined based on one or more characteristics of the battery. The one or more characteristics of the battery may be at least one of a voltage, a resistance, a current, a temperature, a quiescent voltage, and so forth. Additionally, the one or more characteristics of the battery may be determined under different conditions such as a voltage during a max load of the battery. The second computing device may determine the identity of the battery to determine one or more attributes about the battery, such as a manufacturer of the battery, a storage capacity of the battery, a type of the battery, a battery life (e.g. life span) of the battery, a chemical makeup of the battery, and so forth.

At step 1450, a remaining power amount of the battery may be determined. The remaining power amount of the battery may be determined by the second computing device. The second computing device may determine the remaining power amount of the battery based on the power usage of the computing device. The second computing device may determine the remaining power amount of the battery based on the identity of the battery. The second computing device may determine the remaining power amount of the battery based on the identity of the battery and based on the power usage of the first computing device. The second computing device may determine the remaining power amount of the battery based on the storage capacity of the battery. The second computing device may determine the remaining power amount of the battery based on the storage capacity of the battery and the power usage of the first computing device.

At step 1460, a notification that indicates the remaining power amount of the battery may be sent. The second computing device may send the notification. The second computing device may send notification to the first computing device. The second computing device may send the notification to a user device. The notification may indicate that the battery of the first computing device needs to be replaced. The notification may indicate the remaining battery life of the first computing device.

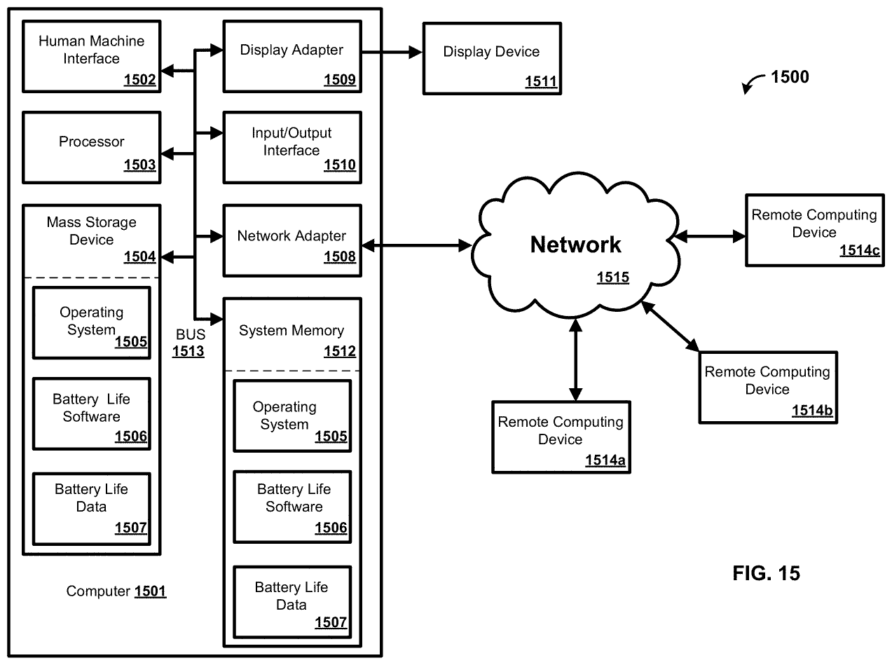

FIG. 15 shows an example system 1500 for determining battery life. The electronic device 101 of FIG. 1, and the battery powered device 202, the network device 204, and/or the computing device 206 of FIGS. 2 & 3 may be a computer 1501 as shown in FIG. 15. The computer 1501 may comprise one or more processors 1503, a system memory 1512, and a bus 1513 that couples various system components including the one or more processors 1503 to the system memory 1512. In the case of multiple processors 1503, the computer 1501 may utilize parallel computing. The bus 1513 is one or more of several possible types of bus structures, including a memory bus or memory controller, a peripheral bus, an accelerated graphics port, or local bus using any of a variety of bus architectures.

The computer 1501 may operate on and/or comprise a variety of computer readable media (e.g., non-transitory). The readable media may be any available media that is accessible by the computer 1501 and may comprise both volatile and non-volatile media, removable and non-removable media. The system memory 1512 comprises computer readable media in the form of volatile memory, such as random access memory (RAM), and/or non-volatile memory, such as read only memory (ROM). The system memory 1512 may store data such as the battery life data 1507 and/or program modules such as the operating system 1505 and the battery life software 1506 that are accessible to and/or are operated on by the one or more processors 1503.

The computer 1501 may also have other removable/non-removable, volatile/non-volatile computer storage media. FIG. 15 shows the mass storage device 1504 which may provide non-volatile storage of computer code, computer readable instructions, data structures, program modules, and other data for the computer 1501. The mass storage device 1504 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1504, such as the operating system 1505 and the battery life software 1506. Each of the operating system 1505 and the battery life software 1506 (or some combination thereof) may have elements of the program modules and the battery life software 1506. The battery life data 1507 may also be stored on the mass storage device 1504. The battery life data 1507 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1515.

A user may enter commands and information into the computer 1501 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1503 via a human machine interface 1502 that is coupled to the bus 1513, but may be connected by other interface and bus structures, such as a parallel port, game port, an IEEE 1394 Port (also known as a Firewire port), a serial port, network adapter 1508, and/or a universal serial bus (USB).

The display device 1511 may also be connected to the bus 1513 via an interface, such as the display adapter 1509. It is contemplated that the computer 1501 may have more than one display adapter 1509 and the computer 1501 may have more than one display device 1511. The display device 1511 may be a monitor, an LCD (Liquid Crystal Display), light emitting diode (LED) display, television, smart lens, smart glass, and/or a projector. In addition to the display device 1511, other output peripheral devices may be components such as speakers (not shown) and a printer (not shown) which may be connected to the computer 1501 via the Input/Output Interface 1510. Any step and/or result of the methods may be output (or caused to be output) in any form to an output device. Such output may be any form of visual representation, including, but not limited to, textual, graphical, animation, audio, tactile, and the like. The display device 1511 and computer 1501 may be part of one device, or separate devices.

The computer 1501 may operate in a networked environment using logical connections to one or more remote computing devices 1514a,b,c. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1501 and a remote computing device 1514a,b,c may be made via a network 1515, such as a local area network (LAN) and/or a general wide area network (WAN). Such network connections may be through the network adapter 1508. The network adapter 1508 may be implemented in both wired and wireless environments. Such networking environments are conventional and commonplace in dwellings, offices, enterprise-wide computer networks, intranets, and the Internet.

Application programs and other executable program components such as the operating system 1505 are shown herein as discrete blocks, although it is recognized that such programs and components reside at various times in different storage components of the computing device 1501, and are executed by the one or more processors 1503 of the computer. An implementation of the battery life software 1506 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, by a computing device, an operating state of the computing device;
determining an amount of power that the computing device uses in the operating state;
determining, based on a period of time the computing device is in the operating state and based on the amount of power, a power usage of the computing device;
determining a storage capacity of the battery; and
determining, based on the power usage of the computing device and the storage capacity of the battery, a remaining power amount of the battery.

2. The method of claim 1, wherein the operating state of the computing device comprises at least one of a sleep state, an awake state, a transmit state, or a receive state.

3. The method of claim 1, further comprising determining, based on one or more characteristics of the battery, the storage capacity of the battery, wherein the one or more characteristics of the battery comprises at least one of a voltage, a resistance, a current, or a temperature.

4. The method of claim 1, wherein the power usage of the computing device is determined without physically measuring the power usage of the computing device.

5. The method of claim 1, wherein the computing device comprises at least one of an Internet of Things (IoT) device, a Consumer Premises Equipment (CPE) device, or a security device.

6. The method of claim 1, further comprising:
sending, to a network device, the power usage of the computing device and one or more characteristics of the battery; and
receiving, from the network device, the storage capacity of the battery.

7. The method of claim 1, further comprising:
determining, based on one or more characteristics of the battery, an identity of the battery; and
determining, based on the identity of the battery, the storage capacity of the battery.

8. A method comprising:
receiving, by a network device, a period of time that a computing device is in an operating state;
determining an amount of power that the computing device uses in the operating state;
determining, based on the period of time that the computing device is in the operating state and based on the amount of power, a power usage of the computing device;
determining a storage capacity of a battery associated with the computing device;
determining, based on the power usage of the computing device and the storage capacity of the battery, a remaining power amount of the battery; and
sending a notification that indicates the remaining power amount of the battery.

9. The method of claim 8, wherein the operating state of the computing device comprises at least one of a sleep state, an awake state, a transmit state, or a receive state.

10. The method of claim 8, further comprising:
receiving one or more characteristics of the battery; and
determining, based on the one or more characteristics of the battery, the storage capacity of the battery, wherein the one or more characteristics of the battery comprises at least one of a voltage, a resistance, a current, or a temperature.

11. The method of claim 8, wherein the power usage of the computing device is determined without physically measuring the power usage of the computing device.

12. The method of claim 8, wherein the computing device comprises at least one of an Internet of Things (IoT) device, a Consumer Premises Equipment (CPE) device, or a security device.

13. The method of claim 8, further comprising:
determining, based on one or more characteristics of the battery, an identity of the battery; and
determining, based on the identity of the battery, the storage capacity of the battery.

14. The method of claim 13, wherein the identity of the battery indicates a maximum potential storage capacity of the battery.

15. A method comprising:
receiving, by a first computing device, a period of time that a second computing device is in an operating state;
determining an amount of power that the second computing device uses in the operating state;
determining, based on the period of time that the second computing device is in the operating state and based on the amount of power, a power usage of the second computing device;
determining an identity of a battery associated with the second computing device;
determining, based on the power usage of the second computing device and the identity of the battery, a remaining power amount of the battery; and
sending a notification that indicates the remaining power amount of the battery.

16. The method of claim 15, wherein the operating state of the second computing device comprises at least one of a sleep state, an awake state, a transmit state, or a receive state.

17. The method of claim 15, further comprising:
receiving one or more characteristics of the battery; and
determining, based on the one or more characteristics of the battery, the identity of the battery, wherein the one or more characteristics of the battery comprises at least one of a voltage, a resistance, a current, or a temperature.

18. The method of claim 15, wherein the second computing device comprises at least one of an Internet of Things (IoT) device, a Consumer Premises Equipment (CPE) device, or a security device.

19. The method of claim 15, further comprising determining, based on the identity of the battery, the storage capacity of the battery.

20. The method of claim 19, wherein the identity of the battery indicates a maximum potential storage capacity of the battery.
